(19) United States
(12) Patent Application Publication
(10) Pub. No.: US 2018/0108086 A1
(43) Pub. Date: Apr. 19, 2018

(54) OBJECT VALUE RANGE OPTIMIZATION BASED ON INTER-OBJECT RELATIONSHIPS

(71) Applicant: Chicago Mercantile Exchange Inc., Chicago, IL (US)

(72) Inventors: Seo Wook Jang, Chicago, IL (US); Michael McDonald, Chicago, IL (US)

(21) Appl. No.: 15/293,766

(22) Filed: Oct. 14, 2016

(51) Int. Cl. G06Q 40/04; G06F 9/46

(52) U.S. Cl. CPC G06Q 40/04; G06F 9/466

(57) ABSTRACT

A range reduction system reduces the range and size of possible values for a target object within an exchange computing system by identifying all possible routes from known object values to the target object. Each route may include a pair of high and low values, and each route may expand the target object range. The reduced range allows selection of a value that ensures that all of the transaction requests associated with base objects remain valid, such that they can still be satisfied by the exchange computing system, and that the transaction requests remain compatible with the target object's reduced range and value selected therein.

### BACKGROUND

Data transaction processing systems process transactions for a variety of interrelated objects which may have associated values computed or otherwise assigned thereto. A value assigned to an object may depend on data received by the data transaction processing system, as well as pre-defined rules and relationships amongst the objects. An efficient data transaction processing system may seek to ensure that transaction requests, related to an object and/or a value assigned, or to be assigned, thereto, received by the system and associated with data remain valid, or can still be performed, even after a value is assigned to the object.

Some computing systems include many, e.g., hundreds or thousands, of objects of differing types, and attempt to compute values for the objects, based partially on data received by the computing system. Some of the objects may be related or based on other objects, and the system environment may impose rules and restrictions on the objects. For computers handling multiple inter-related objects having different rules and restrictions, it is a challenge to efficiently process and compute final values for the objects. Moreover, not all received data, or data stored in a database within the data transaction processing system, may be directly related to an object. Yet an object, or the value thereof, can be influenced by data which is both directly and indirectly related to the object and that is received by and stored within a data transaction processing system.

### BRIEF DESCRIPTION OF THE DRAWINGS

FIG. 1A depicts an illustrative computer network system that may be used to implement aspects of the disclosed embodiments.

FIG. 1B depicts an example market order message management system for implementing the disclosed embodiments.

FIG. 2 depicts an illustrative embodiment of a general computer system for use with the disclosed embodiments.

FIG. 3 depicts an example exchange computing system in accordance with the disclosed embodiments.

FIG. 4 depicts an example exchange computing system in accordance with the disclosed embodiments.

FIG. 5 depicts a plot of values associated with multiple objects for a product.

FIG. 6A depicts objects represented as nodes including composite objects defining relationships between base objects.

FIG. 6B depicts an example plot illustrating ranges generated by an example range reduction system.

FIG. 7 depicts a plot of objects and composite objects composite objects defining relationships between the base objects.

FIG. 8 illustrates example ranges reduced and generated by an example range reduction system.

FIG. 9 illustrates an example input/output block diagram illustrating an example range reduction module in accordance with the disclosed embodiments.

FIG. 10 depicts an example flowchart for implementing an example range reduction system in accordance with the disclosed embodiments.

FIG. 11 depicts a block diagram of an exemplary implementation of a range reduction system in accordance with the disclosed embodiments.

### DETAILED DESCRIPTION

The disclosed embodiments may be implemented in a data transaction processing system that processes data items or objects. Customer or user devices (e.g., computers) may submit electronic data transaction request messages, e.g., inbound messages, to the data transaction processing system over a data communication network. The electronic data transaction request messages may include, for example, transaction matching parameters, such as instructions and/or values, for processing the data transaction request messages within the data transaction processing system. The instructions may be to perform transactions with respect to, or which may result in a change to, one or more data objects, e.g., buy or sell a quantity of a product at a given value. Products, e.g., financial instruments, or order books representing the state of an electronic marketplace for a product, may be represented as data objects within the exchange computing system. The instructions may also be conditional, e.g., buy or sell a quantity of a product at a given value if a trade for the product is executed at some other reference value. The data transaction processing system may include a specifically configured matching processor that matches, e.g., automatically, electronic data transaction request messages comprising opposing operations for the same one of the data items. The specifically configured matching processor may match electronic data transaction request messages based on multiple transaction matching parameters from the different client computers. The specifically configured matching processor may additionally generate information reported to data recipient computing systems via outbound messages published via one or more data feeds.

In data transaction processing systems, it is often desirable to maintain or preserve previously received transaction requests that include data by optimizing internal systems to select values for a data object, e.g., a target data object, that conform with, or otherwise are consistent or comply with, the received data.

The disclosed embodiments relate generally to a data transaction processing system which includes a range reduction system for reducing a value range for a target object, such that a selected value of the target object is consistent with, conforms with, or falls within the bounds associated with, other data stored within the data transaction processing system, in turn ensuring that transaction requests associated with the other data are not violated, i.e., the transaction requests remain valid requests that the exchange computing system can perform. By reducing the range associated with a target object, the range reduction system may reduce the amount of data associated with a target object.

The disclosed range reduction system improves upon the technical field of data computation within a data transaction processing system via a specific application involving particular rules defining how a data range is computed that ensure that transaction requests associated with other data stored within the system, e.g., received data, are not rendered invalid (e.g., values computed for a data object are consistent with previously received data for other data objects). Said another way, the disclosed range reduction system maximizes the number of transaction requests, which are associated with previously received data, that can still be performed after a value is selected for a target object. The system includes objects, including base objects (one of which is a target object, for which the system optimizes a stored value range) and composite objects defining a transaction between two base objects. As used herein, a route exists between, or connects, two base objects if the exchange computing system has received a transaction request for the composite object related to the two base objects. A route also exists between, or connects, two base objects if multiple shorter routes (e.g., a route directly connecting two base objects) can be connected, via a common base object, to form a longer route (e.g., a route including multiple base objects). The disclosed embodiments identify whether one or more routes exist between base objects and associate a high and a low value with each identified route between base objects. Each high low value pair increases, or could increase, the overall range associated with the target object. The target object range is then used to determine a value for the target object that conforms to previously received data, or, said another way, the target object range is then used to determine a value for the target object that does not invalidate, or make impossible, inoperative, or non-transactable, a transaction request associated with the previously received data. The data may be received by the data transaction processing system from external, i.e., outside the data transaction processing system, sources.

For example, a user may submit an electronic data transaction request message (e.g., orders) including a request to buy or sell a composite object (e.g., a spread between two futures contracts), which defines a transaction between two base objects, at a specified value. The range reduction system attempts to select a value for a target object, which may be different from the two base objects, such that the electronic data transaction request message associated with the specified value can still be satisfied, or fulfilled. The particular implementation of the disclosed range reduction system considers or accounts for all data existing within the data transaction processing system that is directly or indirectly related to a target object. The impact of direct or indirect data may be user configurable. Thus, data from composite objects not including a known base object or a target object may still be used to determine a range of values for the target object. The reduced range may also require less memory due to its smaller size, and accordingly decrease storage requirements for an exchange computing system, while ensuring that previously received transaction requests can still be satisfied, or do not become impossible to satisfy, or inoperative.

The disclosed embodiments are accordingly directed to a particular and practical application of value computation that identifies all data stored within the data transaction processing system that is directly or indirectly related to a target object, and considers such data in a weighted manner before computing a value for the target object, such that transaction requests associated with the stored/received data can still be satisfied. At least some of the problems solved by the disclosed system are specifically rooted in technology, specifically, receiving data from outside of the data transaction processing system, e.g., from users of the data transaction processing system submitting data, which is desirable to maintain and use, and computing a value while maintaining the possibility that transaction requests associated with the previously received data can still be satisfied, e.g., ensuring that the value computation does not remove or negate previously received transaction requests and associated data from the data transaction processing system.

The range reduction system may be applicable to any system that receives subjective, biased, or prejudiced data (e.g., for composite objects or base objects) from external sources and attempts to select an objective value for a target object such that an action or request associated with the received data can still be performed.

In one embodiment, the range reduction system is a particular practical and technological solution for a centralized processing system that receives data, e.g., from user input, and computes values that can negate, or make impossible, requests associated with the received data, thus frustrating the data submitter's original data submission/transaction request. Data received by the data transaction processing system, e.g., submitted by a user, is considered to be an important indicator regarding the state of a market for an object, and it is thus desirable to use the received data without negating a transaction request associated with the received data. When a transaction request, which is associated with data such as a specified value, submitted by a user becomes impossible to perform, e.g., due to a value selected for a target object, the transaction request becomes an unnecessary use of infrastructure and network bandwidth. Such technologically rooted problems may be solved by means of a technical solution, namely, identifying a reduced data range from which to compute a value for a target object. The disclosed embodiments solve a problem arising in trading and transaction processing where incoming requests each have permission to impact, e.g., modify, a central database, e.g., a central limit order book when the data transaction processing system is an exchange computing system.

Accordingly, the resulting problem is a problem arising in computer systems due to the high volume of disparate data relating to inter-related objects processed by an exchange computing system. The solutions disclosed herein are, in one embodiment, implemented as automatic responses and actions by an exchange computing system computer.

In one embodiment, the range reduction system optimizes overall system performance by determining and selecting object values that do not render invalid, or inoperative, or non-transactable, previously received transaction requests, where the previously received transaction requests are requested based on pre-defined rules and/or relationships between different objects.

Thus, the disclosed embodiments reduce the load on a computer by identifying and eliminating solutions that would result in undesirable object relationships. In other words, the disclosed embodiments rely on desirable object relationships to select object values, so that the selected object values result in the desired object relationships. The desired object relationships may be derived from transaction requests and associated data input into the system. In one embodiment, the desired object relationships reflect a high level of overall system performance and user satisfaction.

In one embodiment, the disclosed embodiments may be implemented to determine object values, or a range of values, so that a maximum number of inter-object transactions can be enabled, such that a maximum amount of received data values associated with the inter-object transactions can remain valid, i.e., all of the values from the determined range of values for a given data object are consistent with a maximum amount of received data values for other data objects. The relationship logic may be pre-configured into a computer, such that the computer optimizes its solutions to conform to as many of the pre-configured logic or criterion as it can.

Objects may be implemented in code, using, among other things, a tangible computer-readable medium comprising computer-executable instructions (e.g., executable software code). Alternatively, objects may be implemented as software code, firmware code, specifically configured hardware or processors, and/or a combination of the aforementioned. An object may be implemented and stored as a set of related data, e.g., a database. Objects may be implemented using a pre-defined data structure. An object may be implemented as an instance of a class that contains data and methods for processing the data. For example, an object may be a self-contained entity that includes data and procedures to manipulate the data. An object may be any item in the computing environment that can be individually manipulated, selected or processed. Objects may be exposed as shapes, pictures or words in a display screen or in a user interface.

In an exemplary implementation of the disclosed embodiments, a range reduction system stores a first range of values for a first base object, e.g., the target object. The range reduction system also stores a value for a second base object. The range reduction system identifies all routes between the first base object and the second base object, where each identified route is defined by one or more composite objects, each composite object is associated with at least two constituent base objects, and each identified route includes at least one composite object that is associated with at least one of the first base object or the second base object. For each identified route, the range reduction system stores a high and a low value for each composite object defining the identified route. The range reduction system then determines a route range based on the second base object value and the high and low values of the composite objects defining the identified route. Next, the range reduction system generates a second range of values based on the route ranges of the identified routes, the second range of values being smaller than the first range of values. The range reduction system then deletes the first range of values, stores the second range of values for the first base object, and selects a value for the first base object based on the second range of values.

For example, one exemplary environment where a range reduction system may be desirable is in electronic financial exchanges, such as a futures exchange, such as the Chicago Mercantile Exchange Inc. (CME). The CME receives orders for multiple futures contracts that expire at, or have a delivery date of, different months. The near months (e.g., the ones occurring earlier than later months) may have enough liquidity or market activity such that their settlement or final price can be accurately determined. The later months may have less liquidity, and their settlement price cannot be easily determined. The disclosed embodiments relate to a range reduction system that uses known (e.g., settled) prices for the near months, and bid-ask information for spread contracts that can be used as a guide to generate a new, smaller range of values for the a later, target month. If a value for the target month is selected from the small range, orders received for the spread contracts are preserved, e.g., they can still be performed, so that the sender of those spread contract orders does not have to modify and resubmit orders for those spread contracts.

In particular, an exchange may offer multiple products and contracts for purchase that may be represented as objects in the computing system. The associated costs and values of objects may be considered to be related data sets. An exchange computer system may also be constrained by the tradable positions of markets, such as for example, bid and ask values for the different contracts, available on the exchange.

A financial instrument trading system, such as a futures exchange, such as the Chicago Mercantile Exchange Inc. (CME), provides a contract market where financial instruments, e.g., futures and options on futures, are traded using electronic systems. “Futures” is a term used to designate all contracts for the purchase or sale of financial instruments or physical commodities for future delivery or cash settlement on a commodity futures exchange. A futures contract is a legally binding agreement to buy or sell a commodity at a specified price at a predetermined future time. An option contract is the right, but not the obligation, to sell or buy the underlying instrument (in this case, a futures contract) at a specified price within a specified time. The commodity to be delivered in fulfillment of the contract, or alternatively the commodity for which the cash market price shall determine the final settlement price of the futures contract, is known as the contract's underlying reference or “underlier.” The terms and conditions of each futures contract are standardized as to the specification of the contract's underlying reference commodity, the quality of such commodity, quantity, delivery date, and means of contract settlement. Cash settlement is a method of settling a futures contract whereby the parties effect final settlement when the contract expires by paying/receiving the loss/gain related to the contract in cash, rather than by effecting physical sale and purchase of the underlying reference commodity at a price determined by the futures contract, price. Options and futures may be based on more generalized market indicators, such as stock indices, interest rates, futures contracts and other derivatives.

An exchange may provide for a centralized “clearing house” through which trades made must be confirmed, matched, and settled each day until offset or delivered. The clearing house may be an adjunct to an exchange, and may be an operating division of an exchange, which is responsible for settling trading accounts, clearing trades, collecting and maintaining performance bond funds, regulating delivery, and reporting trading data. One of the roles of the clearing house is to mitigate credit risk. Clearing is the procedure through which the clearing house becomes buyer to each seller of a futures contract, and seller to each buyer, also referred to as a novation, and assumes responsibility for protecting buyers and sellers from financial loss due to breach of contract, by assuring performance on each contract. A clearing member is a firm qualified to clear trades through the clearing house.

The clearing house of an exchange clears, settles and guarantees matched transactions in contracts occurring through the facilities of the exchange. In addition, the clearing house establishes and monitors financial requirements for clearing members and conveys certain clearing privileges in conjunction with the relevant exchange markets.

The clearing house establishes clearing level performance bonds (margins) for all products of the exchange and establishes minimum performance bond requirements for customers of such products. A performance bond, also referred to as a margin requirement, corresponds with the funds that must be deposited by a customer with his or her broker, by a broker with a clearing member or by a clearing member with the clearing house, for the purpose of insuring the broker or clearing house against loss on open futures or options contracts. This is not a part payment on a purchase. The performance bond helps to ensure the financial integrity of brokers, clearing members and the exchange as a whole. The performance bond refers to the minimum dollar deposit required by the clearing house from clearing members in accordance with their positions. Maintenance, or maintenance margin, refers to a sum, usually smaller than the initial performance bond, which must remain on deposit in the customer's account for any position at all times. The initial margin is the total amount of margin per contract required by the broker when a futures position is opened. A drop in funds below this level requires a deposit back to the initial margin levels, i.e., a performance bond call. If a customer's equity in any futures position drops to or under the maintenance level because of adverse price action, the broker must issue a performance bond/margin call to restore the customer's equity. A performance bond call, also referred to as a margin call, is a demand for additional funds to bring the customer's account back up to the initial performance bond level whenever adverse price movements cause the account to go below the maintenance.

The exchange derives its financial stability in large part by removing debt obligations among market participants as they occur. This is accomplished by determining a settlement price at the close of the market each day for each contract and marking all open positions to that price, referred to as “mark to market.” Every contract is debited or credited based on that trading session's gains or losses. As prices move for or against a position, funds flow into and out of the trading account. In the case of the CME, each business day by 6:40 a.m. Chicago time, based on the mark-to-the-market of all open positions to the previous trading day's settlement price, the clearing house pays to or collects cash from each clearing member. This cash flow, known as settlement variation, is performed by CME's settlement banks based on instructions issued by the clearing house. All payments to and collections from clearing members are made in “same-day” funds. In addition to the 6:40 a.m. settlement, a daily intra-day mark-to-the market of all open positions, including trades executed during the overnight GLOBEX®, the CME's electronic trading systems, trading session and the current day's trades matched before 11:15 a.m., is performed using current prices. The resulting cash payments are made intra-day for same day value. In times of extreme price volatility, the clearing house has the authority to perform additional intra-day mark-to-the-market calculations on open positions and to call for immediate payment of settlement variation. CME's mark-to-the-market settlement system differs from the settlement systems implemented by many other financial markets, including the interbank, Treasury securities, over-the-counter foreign exchange and debt, options, and equities markets, where participants regularly assume credit exposure to each other. In those markets, the failure of one participant can have a ripple effect on the solvency of the other participants. Conversely, CME's mark-to-the-market system does not allow losses to accumulate over time or allow a market participant the opportunity to defer losses associated with market positions.

In order to minimize risk to the exchange while minimizing the burden on members, it is desirable to approximate the requisite performance bond or margin requirement as closely as possible to the actual positions of the account at any given time. An exchange may use a settlement method to determine the position of a contract. It may be difficult to quickly and efficiently select the best settlement price when multiple potential settlement prices can be used. For example, when multiple potential settlement prices can be used, differentiating between the multiple potential settlement prices may be a time-consuming task, or the logic for determining the best settlement price may be context or case specific.

While the disclosed embodiments may be discussed in relation to futures and/or options on futures trading, it should be appreciated that the disclosed embodiments may be applicable to any equity, fixed income security, currency, commodity, options or futures trading system or market now available or later developed. It should be appreciated that a trading environment, such as a futures exchange as described herein, implements one or more economic markets where rights and obligations may be traded. As such, a trading environment may be characterized by a need to maintain market integrity, transparency, predictability, fair/equitable access and participant expectations with respect thereto. For example, an exchange must respond to inputs, such as trader orders, cancelations, etc., in a manner as expected by the market participants, such as based on market data, e.g., prices, available counter-orders, etc., to provide an expected level of certainty that transactions will occur in a consistent and predictable manner and without unknown or unascertainable risks. In addition, it should be appreciated that electronic trading systems further impose additional expectations and demands by market participants as to transaction processing speed, latency, capacity and response time, while creating additional complexities relating thereto. Accordingly, as will be described, the disclosed embodiments may further include functionality to ensure that the expectations of market participants are met, e.g., that transactional integrity and predictable system responses are maintained.

As was discussed above, electronic trading systems ideally attempt to offer an efficient, fair and balanced market where market prices reflect a true consensus of the value of products traded among the market participants, where the intentional or unintentional influence of any one market participant is minimized if not eliminated, and where unfair or inequitable advantages with respect to information access are minimized if not eliminated.

Although described below in connection with examples involving instruments having multiple components, such as calendar and butterfly spread instruments, the methods described herein are well suited for determining final values for any variety of objects conforming to a set of rules or relationships (e.g., spread relationships between two futures contracts), such as for example, determining settlement prices for a variety of instruments based on a related market.

Generally, the disclosed embodiments may be applicable to any computer processing system that is constrained by a variety of rules and data values. When a computer processor attempts to compute a large number of data sets in an environment including rules constraints and data constraints, the number of possible solutions or combinations of values can become unwieldy.

The disclosed embodiments may be applicable to contracts for any type of underlie commodity, equity, option, or futures trading system or market now available or later developed. The disclosed embodiments are also not limited to intra-market spread instruments, and accordingly may also be used in connection with inter-market spread instruments for contracts associated with different commodities.

While the disclosed embodiments may be described in reference to the CME, it should be appreciated that these embodiments are applicable to any exchange. Such other exchanges may include a clearing house that, like the CME clearing house, clears, settles and guarantees all matched transactions in contracts of the exchange occurring through its facilities. In addition, such clearing houses establish and monitor financial requirements for clearing members and convey certain clearing privileges in conjunction with the relevant exchange markets.

The disclosed embodiments are also not limited to uses by a clearing house or exchange for purposes of enforcing a performance bond or margin requirement. For example, a market participant may use the disclosed embodiments in a simulation or other analysis of a portfolio. In such cases, the settlement price may be useful as an indication of a value at risk and/or cash flow obligation rather than a performance bond. The disclosed embodiments may also be used by market participants or other entities to forecast or predict the effects of a prospective position on the margin requirement of the market participant.

The methods and systems described herein may be integrated or otherwise combined with various risk management methods and systems, such as the risk management methods and systems described in U.S. Pat. No. 7,769,667 entitled “System and Method for Activity Based Margining” (the '667 patent”), the entire disclosure of which is incorporated by reference herein and relied upon. For example, the methods and systems described herein may be configured as a component or module of the risk management systems described in the above-referenced patent. Alternatively or additionally, the disclosed methods may generate data to be provided to the systems described in the above-referenced patent. For example, the settlement prices determined by the disclosed embodiments may be incorporated into margin requirement(s) determined by the risk management method or system.

In one embodiment, the disclosed methods and systems are integrated or otherwise combined with the risk management system implemented by CME called Standard Portfolio Analysis of Risk™ (SPAN®). The SPAN system bases performance bond requirements on the overall risk of the portfolios using parameters as determined by CME's Board of Directors, and thus represents a significant improvement over other performance bond systems, most notably those that are “strategy-based” or “delta-based.” Further details regarding SPAN are set forth in the '667 patent.

In one embodiment, the disclosed embodiments may be integrated or combined with a margin model, such as a margin model different from SPAN. For example, a margin model may be implemented to generate multiple settlement prices.

The embodiments may be described in terms of a distributed computing system. The particular examples identify a specific set of components useful in a futures and options exchange. However, many of the components and inventive features are readily adapted to other electronic trading environments. The specific examples described herein may teach specific protocols and/or interfaces, although it should be understood that the principles involved may be extended to, or applied in, other protocols and interfaces.

It should be appreciated that the plurality of entities utilizing or involved with the disclosed embodiments, e.g., the market participants, may be referred to by other nomenclature reflecting the role that the particular entity is performing with respect to the disclosed embodiments and that a given entity may perform more than one role depending upon the implementation and the nature of the particular transaction being undertaken, as well as the entity's contractual and/or legal relationship with another market participant and/or the exchange.

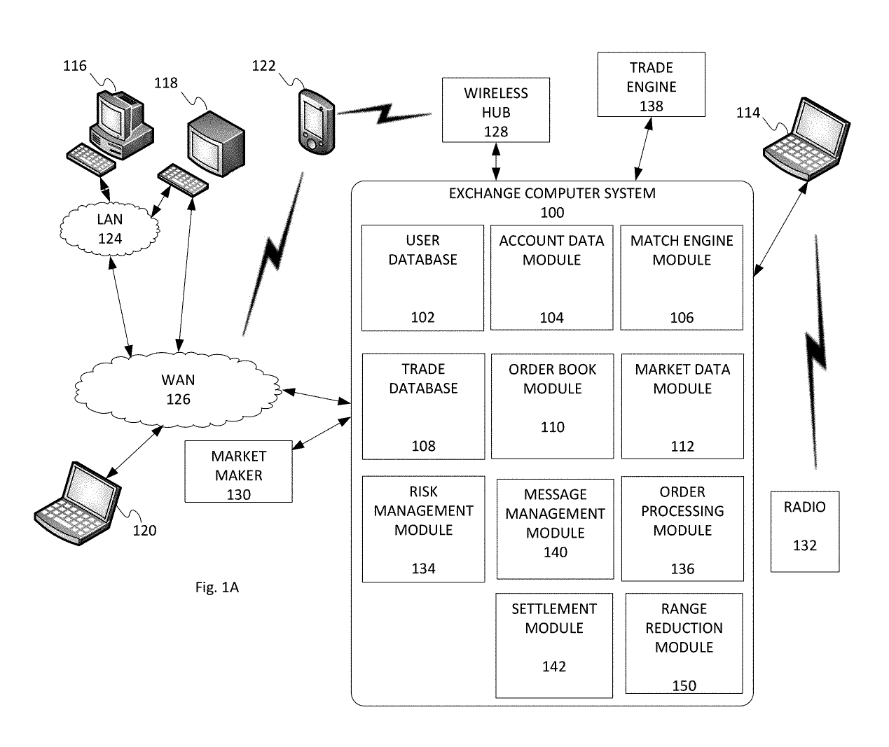

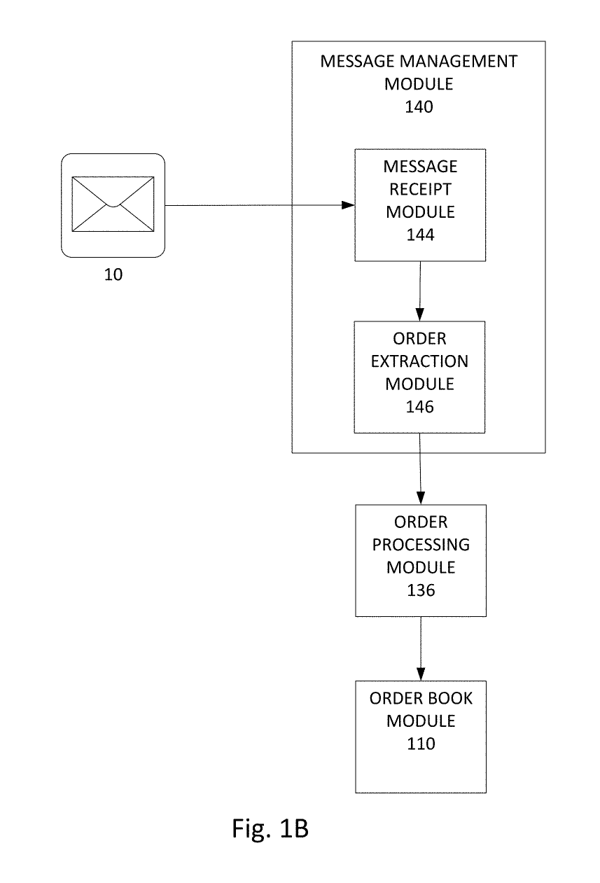

An exemplary trading network environment for implementing trading systems and methods is shown in FIG. 1A. An exchange computer system 100 receives messages that include orders and transmits market data related to orders and trades to users, such as via wide area network 126 and/or local area network 124 and computer devices 114, 116, 118, 120 and 122, as described herein, coupled with the exchange computer system 100.

Herein, the phrase “coupled with” is defined to mean directly connected to or indirectly connected through one or more intermediate components. Such intermediate components may include both hardware and software based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

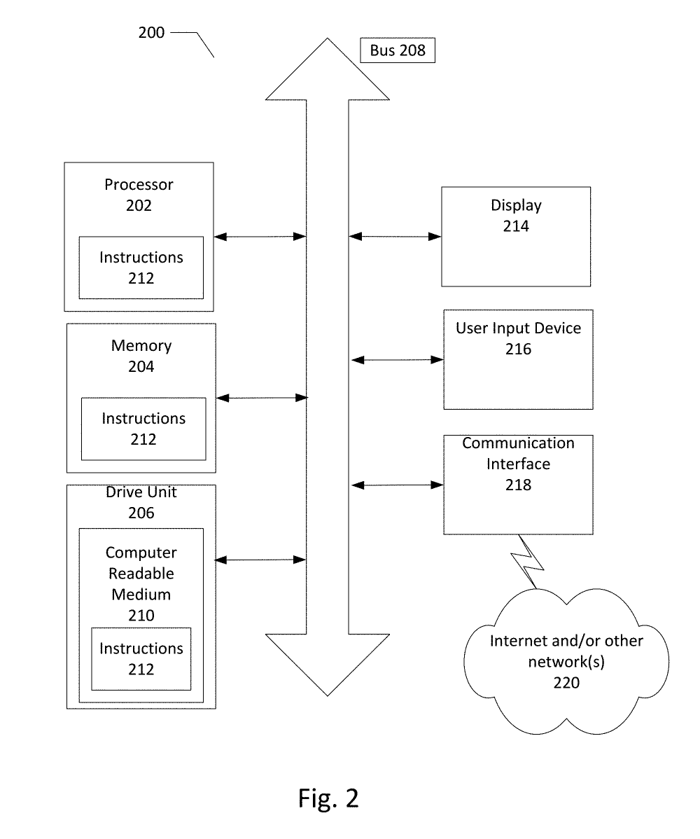

The exchange computer system 100 may be implemented with one or more mainframe, desktop or other computers, such as the example computer 200 described herein with respect to FIG. 2. A user database 102 may be provided which includes information identifying traders and other users of exchange computer system 100, such as account numbers or identifiers, user names and passwords. An account data module 104 may be provided which may process account information that may be used during trades.

A match engine module 106 may be included to match bid and offer prices and may be implemented with software that executes one or more algorithms for matching bids and offers. A trade database 108 may be included to store information identifying trades and descriptions of trades. In particular, a trade database may store information identifying the time that a trade took place and the contract price. An order book module 110 may be included to compute or otherwise determine current bid and offer prices, e.g., in a continuous auction market, or also operate as an order accumulation buffer for a batch auction market.

A market data module 112 may be included to collect market data and prepare the data for transmission to users.

A risk management module 134 may be included to compute and determine a user's risk utilization in relation to the user's defined risk thresholds. The risk management module 134 may also be configured to determine risk assessments or exposure levels in connection with positions held by a market participant.

The risk management module 134 may be configured to administer, manage or maintain one or more margining mechanisms implemented by the exchange computer system 100. Such administration, management or maintenance may include managing a number of database records reflective of margin accounts of the market participants. In some embodiments, the risk management module 134 implements one or more aspects of the disclosed embodiments, including, for instance, principal component analysis (PCA) based margining, in connection with interest rate swap (IRS) portfolios, as described herein.

An order processing module 136 may be included to decompose delta-based, spread instrument, bulk and other types of composite orders for processing by the order book module 110 and/or the match engine module 106. The order processing module 136 may also be used to implement one or more procedures related to clearing an order.

A message management module 140 may be included to, among other things, receive, and extract orders from, electronic messages as is indicated with one or more aspects of the disclosed embodiments.

A settlement module 142 (or settlement processor or other payment processor) may be included to provide one or more functions related to settling or otherwise administering transactions cleared by the exchange. Settlement module 142 of the exchange computer system 100 may implement one or more settlement price determination techniques. Settlement-related functions need not be limited to actions or events occurring at the end of a contract term. For instance, in some embodiments, settlement-related functions may include or involve daily or other mark to market settlements for margining purposes. In some cases, the settlement module 142 may be configured to communicate with the trade database 108 (or the memory(ies) on which the trade database 108 is stored) and/or to determine a payment amount based on a spot price, the price of the futures contract or other financial instrument, or other price data, at various times. The determination may be made at one or more points in time during the term of the financial instrument in connection with a margining mechanism. For example, the settlement module 142 may be used to determine a mark to market amount on a daily basis during the term of the financial instrument. Such determinations may also be made on a settlement date for the financial instrument for the purposes of final settlement.

In some embodiments, the settlement module 142 may be integrated to any desired extent with one or more of the other modules or processors of the exchange computer system 100. For example, the settlement module 142 and the risk management module 134 may be integrated to any desired extent. In some cases, one or more margining procedures or other aspects of the margining mechanism(s) may be implemented by the settlement module 142.

A range reduction module 150 may be included to select, for example, the outer boundaries of a range based on other inter-related objects, as described herein.

It should be appreciated that concurrent processing limits may be defined by or imposed separately or in combination on one or more of the trading system components, including the user database 102, the account data module 104, the match engine module 106, the trade database 108, the order book module 110, the market data module 112, the risk management module 134, the order processing module 136, the message management module 140, the settlement module 142, range reduction module 150, or other component of the exchange computer system 100.

The disclosed range reduction module may be implemented as part of the settlement module 142. However, it will be appreciated that the disclosed mechanisms may be implemented at any logical and/or physical point(s), or combinations thereof, at which the relevant information/data may be monitored or is otherwise accessible or measurable, including one or more gateway devices, modems, the computers or terminals of one or more market participants, etc.

One skilled in the art will appreciate that one or more modules described herein may be implemented using, among other things, a tangible computer-readable medium comprising computer-executable instructions (e.g., executable software code). Alternatively, modules may be implemented as software code, firmware code, specifically configured hardware or processors, and/or a combination of the aforementioned. For example, the modules may be embodied as part of an exchange 100 for financial instruments. It should be appreciated the disclosed embodiments may be implemented as a different or separate module of the exchange computer system 100, or a separate computer system coupled with the exchange computer system 100 so as to have access to margin account record, pricing, and/or other data. As described herein, the disclosed embodiments may be implemented as a centrally accessible system or as a distributed system, e.g., where some of the disclosed functions are performed by the computer systems of the market participants.

As shown in FIG. 1A, the exchange computer system 100 further includes a message management module 140 which may implement, in conjunction with the market data module 112, the disclosed mechanisms for managing electronic messages containing financial data sent between an exchange and a plurality of market participants, or vice versa. However, as was discussed above, the disclosed mechanisms may be implemented at any logical and/or physical point(s) through which the relevant message traffic, and responses thereto, flows or is otherwise accessible, including one or more gateway devices, modems, the computers or terminals of one or more traders, etc.

FIG. 1B illustrates an embodiment of market order message management as implemented using the message management module 140 and order book module 110 of the exchange computer system 100. As such, a message 10 may be received from a market participant at the exchange computer system 100 by a message receipt module 144 of the message management module 140. The message receipt module 144 processes the message 10 by interpreting the content of the message based on the message transmit protocol, such as the transmission control protocol (“TCP”), to provide the content of the message 10 for further processing by the exchange computer system.

For example, the message management module 140 may determine the transaction type of the transaction requested in a given message. A message may include an instruction to perform a type of transaction. The transaction type may be, in one embodiment, a request/offer/order to either buy or sell a specified quantity or units of a financial instrument at a specified price or value.

Further processing may be performed by the order extraction module 146. The order extraction module 146 may be configured to detect, from the content of the message 10 provided by the message receipt module 144, characteristics of an order for a transaction to be undertaken in an electronic marketplace. For example, the order extraction module 146 may identify and extract order content such as a price, product, volume, and associated market participant for an order. The order extraction module 146 may also identify and extract data indicating an action to be executed by the exchange computer system 100 with respect to the extracted order. The order extraction module may also identify and extract other order information and other actions associated with the extracted order. All extracted order characteristics, other information, and associated actions extracted from a message for an order may be collectively considered an order as described and referenced herein.

Order or message characteristics may include, for example, the state of the system after a message is received, arrival time (e.g., the time a message arrives at the MSG or Market Segment Gateway), message type (e.g., new, modify, cancel), and the number of matches generated by a message. Order or message characteristics may also include market participant side (e.g., buy or sell) or time in force (e.g., a good until end of day order that is good for the full trading day, a good until canceled ordered that rests on the order book until matched, or a fill or kill order that is canceled if not filled immediately).

The order may be communicated from the order extraction module 146 to an order processing module 136. The order processing module 136 may be configured to interpret the communicated order, and manage the order characteristics, other information, and associated actions as they are processed through an order book module 110 and eventually transacted on an electronic market. For example, the order processing module 136 may store the order characteristics and other content and execute the associated actions. In an embodiment, the order processing module may execute an associated action of placing the order into an order book for an electronic trading system managed by the order book module 110. In an embodiment, placing an order into an order book and/or into an electronic trading system may be considered a primary action for an order. The order processing module 136 may be configured in various arrangements, and may be configured as part of the order book module 110, part of the message management module 140, or as an independent functioning module.

The embodiments described herein utilize trade related electronic messages such as mass quote messages, individual order messages, modification messages, cancelation messages, etc., so as to enact trading activity in an electronic market. The trading entity and/or market participant may have one or multiple trading terminals associated with the session. Furthermore, the financial instruments may be financial derivative products. Derivative products may include futures contracts, options on futures contracts, futures contracts that are functions of or related to other futures contracts, swaps, swaptions, or other financial instruments that have their price related to or derived from an underlying product, security, commodity, equity, index, or interest rate product. In one embodiment, the orders are for options contracts that belong to a common option class. Orders may also be for baskets, quadrants, other combinations of financial instruments, etc. The option contracts may have a plurality of strike prices and/or comprise put and call contracts. A mass quote message may be received at an exchange. As used herein, an exchange computing system 100 includes a place or system that receives and/or executes orders.

In an embodiment, a plurality of electronic messages is received from the network. The plurality of electronic messages may be received at a network interface for the electronic trading system. The plurality of electronic messages may be sent from market participants. The plurality of messages may include order characteristics and be associated with actions to be executed with respect to an order that may be extracted from the order characteristics. The action may involve any action as associated with transacting the order in an electronic trading system. The actions may involve placing the orders within a particular market and/or order book of a market in the electronic trading system.

In an embodiment, the market may operate using characteristics that involve collecting orders over a period of time, such as a batch auction market. In such an embodiment, the period of time may be considered an order accumulation period. The period of time may involve a beginning time and an ending time, with orders placed in the market after the beginning time, and the placed order matched at or after the ending time. As such, the action associated with an order extracted from a message may involve placing the order in the market within the period of time. Also, electronic messages may be received prior to or after the beginning time of the period of time.

The electronic messages may also include other data relating to the order. In an embodiment, the other data may be data indicating a particular time in which the action is to be executed. As such, the order may be considered a temporally specific order. The particular time in which an action is undertaken may be established with respect to any measure of absolute or relative time. In an embodiment, the time in which an action is undertaken may be established with reference to the beginning time of the time period or ending time of the time period in a batch auction embodiment. For example, the particular time may be a specific amount of time, such as 10 milliseconds, prior to the ending time of an order accumulation period in the batch auction. Further, the order accumulation period may involve dissecting the accumulation period into multiple consecutive, overlapping, or otherwise divided, sub-periods of time. For example, the sub-periods may involve distinct temporal windows within the order accumulation period. As such, the particular time may be an indicator of a particular temporal window during the accumulation period. For example, the particular time may be specified as the last temporal window prior to the ending time of the accumulation period.

In an embodiment, the electronic message may also include other actions to be taken with respect to the order. These other actions may be actions to be executed after the initial or primary action associated with the order. For example, the actions may involve modifying or canceling an already placed order. Further, in an embodiment, the other data may indicate order modification characteristics. For example, the other data may include a price or volume change in an order. The other actions may involve modifying the already placed order to align with the order modification characteristics, such as changing the price or volume of the already placed order.

In an embodiment, other actions may be dependent actions. For example, the execution of the actions may involve a detection of an occurrence of an event. Such triggering events may be described as other data in the electronic message. For example, the triggering event may be a release of an economic statistic from an organization relating to a product being bought or sold in the electronic market, a receipt of pricing information from a correlated electronic market, a detection of a change in market sentiment derived from identification of keywords in social media or public statements of officials related to a product being bought or sold in the electronic market, and/or any other event or combination of events which may be detected by an electronic trading system.

In an embodiment, the action, or a primary action, associated with an order may be executed. For example, an order extracted from electronic message order characteristics may be placed into a market, or an electronic order book for a market, such that the order may be matched with other orders counter thereto.

In an embodiment involving a market operating using batch auction principles, the action, such as placing the order, may be executed subsequent to the beginning time of the order accumulation period, but prior to the ending time of the order accumulation period. Further, as indicated above, a message may also include other information for the order, such as a particular time the action is to be executed. In such an embodiment, the action may be executed at the particular time. For example, in an embodiment involving a batch auction process having sub-periods during an order accumulation period, an order may be placed during a specified sub-period of the order accumulation period. The disclosed embodiments may be applicable to batch auction processing, as well as continuous processing.

Also, it may be noted that messages may be received prior or subsequent to the beginning time of an order accumulation period. Orders extracted from messages received prior to the beginning time may have the associated actions, or primary actions such as placing the order, executed at any time subsequent to the beginning time, but prior to the ending time, of the order accumulation period when no particular time for the execution is indicated in the electronic message. In an embodiment, messages received prior to the beginning time but not having a particular time specified will have the associated action executed as soon as possible after the beginning time. Because of this, specifying a time for order action execution may allow a distribution and more definite relative time of order placement so as to allow resources of the electronic trading system to operate more efficiently.

In an embodiment, the execution of temporally specific messages may be controlled by the electronic trading system such that a limited or maximum number may be executed in any particular accumulation period, or sub-period. In an embodiment, the order accumulation time period involves a plurality of sub-periods involving distinct temporal windows, a particular time indicated by a message may be indicative of a particular temporal window of the plurality of temporal windows, and the execution of the at least one temporally specific message is limited to the execution of a specified sub-period maximum number of temporally specific messages during a particular sub-period. The electronic trading system may distribute the ability to submit temporally specific message to selected market participants. For example, only five temporally specific messages may be allowed in any one particular period or sub-period. Further, the ability to submit temporally specific messages within particular periods or sub-periods may be distributed based on any technique. For example, the temporally specific messages for a particular sub-period may be auctioned off or otherwise sold by the electronic trading system to market participants. Also, the electronic trading system may distribute the temporally specific messages to preferred market participants, or as an incentive to participate in a particular market.

In an embodiment, an event occurrence may be detected. The event occurrence may be the occurrence of an event that was specified as other information relating to an order extracted from an electronic message. The event may be a triggering event for a modification or cancelation action associated with an order. The event may be detected subsequent to the execution of the first action when an electronic message further comprises the data representative of the event and a secondary action associated with the order. In an embodiment involving a market operating on batch auction principles, the event may be detected subsequent to the execution of a first action, placing an order, but prior to the ending time of an order accumulation period in which the action was executed.

In an embodiment, other actions associated with an order may be executed. The other actions may be any action associated with an order. For example, the action may be a conditional action that is executed in response to a detection of an occurrence of an event. Further, in a market operating using batch auction principles, the conditional action may be executed after the placement of an order during an order accumulation period, but in response to a detection of an occurrence of an event prior to an ending time of the order accumulation period. In such an embodiment, the conditional action may be executed prior to the ending time of the order accumulation period. For example, the placed order may be canceled, or modified using other provided order characteristics in the message, in response to the detection of the occurrence of the event.

An event may be a release of an economic statistic or a fluctuation of prices in a correlated market. An event may also be a perceptible change in market sentiment of a correlated market. A change may be perceptible based on a monitoring of orders or social media for keywords in reference to the market in question. For example, electronic trading systems may be configured to be triggered for action by a use of keywords during a course of ongoing public statements of officials who may be in a position to impact markets, such as Congressional testimony of the Chairperson of the Federal Reserve System.

The other, secondary, or supplemental action may also be considered a modification of a first action executed with respect to an order. For example, a cancelation may be considered a cancelation of the placement of the order. Further, a secondary action may have other data in the message which indicates a specific time in which the secondary action may be executed. The specific time may be a time relative to a first action, or placement of the order, or relative to an accumulation period in a batch auction market. For example, the specific time for execution of the secondary action may be at a time specified relative and prior to the ending period of the order accumulation period. Further, multiple secondary actions may be provided for a single order. Also, with each secondary action a different triggering event may be provided.

In an embodiment, an incoming transaction may be received. The incoming transaction may be from, and therefore associated with, a market participant of an electronic market managed by an electronic trading system. The transaction may involve an order as extracted from a received message, and may have an associated action. The actions may involve placing an order to buy or sell a financial product in the electronic market, or modifying or deleting such an order. In an embodiment, the financial product may be based on an associated financial instrument which the electronic market is established to trade.

In an embodiment, the action associated with the transaction is determined. For example, it may be determined whether the incoming transaction comprises an order to buy or sell a quantity of the associated financial instrument or an order to modify or cancel an existing order in the electronic market. Orders to buy or sell and orders to modify or cancel may be acted upon differently by the electronic market. For example, data indicative of different characteristics of the types of orders may be stored.

In an embodiment, data relating to the received transaction is stored. The data may be stored in any device, or using any technique, operable to store and provide recovery of data. For example, a memory 204 or computer readable medium 210, may be used to store data, as is described with respect to FIG. 2 in further detail herein. Data may be stored relating received transactions for a period of time, indefinitely, or for a rolling most recent time period such that the stored data is indicative of the market participant's recent activity in the electronic market.

If and/or when a transaction is determined to be an order to modify or cancel a previously placed, or existing, order, data indicative of these actions may be stored. For example, data indicative of a running count of a number or frequency of the receipt of modify or cancel orders from the market participant may be stored. A number may be a total number of modify or cancel orders received from the market participant, or a number of modify or cancel orders received from the market participant over a specified time. A frequency may be a time based frequency, as in a number of cancel or modify orders per unit of time, or a number of cancel or modify orders received from the market participant as a percentage of total transactions received from the participant, which may or may not be limited by a specified length of time.

If and/or when a transaction is determined to be an order to buy or sell a financial product, or financial instrument, other indicative data may be stored. For example, data indicative of quantity and associated price of the order to buy or sell may be stored.

Data indicative of attempts to match incoming orders may also be stored. The data may be stored in any device, or using any technique, operable to store and provide recovery of data. For example, a memory 204 or computer readable medium 210, may be used to store data, as is described with respect to FIG. 2.

The acts of the process as described herein may also be repeated. As such, data for multiple received transactions for multiple market participants may be stored and used as describe herein.

The order processing module 136 may also store data indicative of characteristics of the extracted orders. For example, the order processing module may store data indicative of orders having an associated modify or cancel action, such as by recording a count of the number of such orders associated with particular market participants. The order processing module may also store data indicative of quantities and associated prices of orders to buy or sell a product placed in the market order book 110, as associated with particular market participants.

Also, the order processing module 136 may be configured to calculate and associate with particular orders a value indicative of an associated market participant's market activity quality, which is a value indicative of whether the market participant's market activity increases or tends to increase liquidity of a market. This value may be determined based on the price of the particular order, previously stored quantities of orders from the associated market participant, the previously stored data indicative of previously received orders to modify or cancel as associated with the market participant, and previously stored data indicative of a result of the attempt to match previously received orders stored in association with the market participant. The order processing module 136 may determine or otherwise calculate scores indicative of the quality value based on these stored extracted order characteristics.

Further, electronic trading systems may perform actions on orders placed from received messages based on various characteristics of the messages and/or market participants associated with the messages. These actions may include matching the orders either during a continuous auction process, or at the conclusion of a collection period during a batch auction process. The matching of orders may be by any technique.

The matching of orders may occur based on a priority indicated by the characteristics of orders and market participants associated with the orders. Orders having a higher priority may be matched before orders of a lower priority. This priority may be determined using various techniques. For example, orders that were indicated by messages received earlier may receive a higher priority to match than orders that were indicated by messages received later. Also, scoring or grading of the characteristics may provide for priority determination.

An exchange provides one or more markets for the purchase and sale of various types of products including financial instruments such as stocks, bonds, futures contracts, options, currency, cash, and other similar instruments. Agricultural products and commodities are also examples of products traded on such exchanges. A futures contract is a product that is a contract for the future delivery of another financial instrument such as a quantity of grains, metals, oils, bonds, currency, or cash. Generally, each exchange establishes a specification for each market provided thereby that defines at least the product traded in the market, minimum quantities that must be traded, and minimum changes in price (e.g., tick size). For some types of products (e.g., futures or options), the specification further defines a quantity of the underlying product represented by one unit (or lot) of the product, and delivery and expiration dates. As will be described, the exchange may further define the matching algorithm, or rules, by which incoming orders will be matched/allocated to resting orders.

Market participants, e.g., traders, use software to send orders or messages to the trading platform. The order identifies the product, the quantity of the product the trader wishes to trade, a price at which the trader wishes to trade the product, and a direction of the order (i.e., whether the order is a bid, i.e., an offer to buy, or an ask, i.e., an offer to sell). It will be appreciated that there may be other order types or messages that traders can send including requests to modify or cancel a previously submitted order.

The disclosed embodiments recognize that electronic messages such as incoming messages from market participants, i.e., “outright” messages, e.g., trade order messages, etc., are sent from client devices associated with market participants, or their representatives, to an electronic trading or market system. For example, a market participant may submit an electronic message to the electronic trading system that includes an associated specific action to be undertaken by the electronic trading system, such as entering a new trade order into the market or modifying an existing order in the market. In one embodiment, if a participant wishes to modify a previously sent request, e.g., a prior order which has not yet been processed or traded, they may send a request message comprising a request to modify the prior request.

As used herein, a financial message, or an electronic message, refers both to messages communicated by market participants to an electronic trading or market system and vice versa. The messages may be communicated using packeting or other techniques operable to communicate information between systems and system components. Some messages may be associated with actions to be taken in the electronic trading or market system.

Financial messages communicated to the electronic trading system, also referred to as “inbound” messages, may include associated actions that characterize the messages, such as trader orders, order modifications, order cancelations and the like, as well as other message types. Inbound messages may be sent from market participants, or their representatives, e.g., trade order messages, etc., to an electronic trading or market system. For example, a market participant may submit an electronic message to the electronic trading system that includes an associated specific action to be undertaken by the electronic trading system, such as entering a new trade order into the market or modifying an existing order in the market. In one exemplary embodiment, the incoming request itself, e.g., the inbound order entry, may be referred to as an iLink message. iLink is a bidirectional communications/message protocol/message format implemented by the Chicago Mercantile Exchange Inc.

Financial messages communicated from the electronic trading system, referred to as “outbound” messages, may include messages responsive to inbound messages, such as confirmation messages, or other messages such as market update messages, quote messages, and the like. Outbound messages may be disseminated via data feeds.

Financial messages may further be categorized as having or reflecting an impact on a market or electronic marketplace, also referred to as an “order book” or “book,” for a traded product, such as a prevailing price therefore, number of resting orders at various price levels and quantities thereof, etc., or not having or reflecting an impact on a market or a subset or portion thereof. In one embodiment, an electronic order book may be understood to be an electronic collection of the outstanding or resting orders for a financial instrument.

For example, a request to place a trade may result in a response indicative of the trade either being matched with, or being rested on an order book to await, a suitable counter-order. This response may include a message directed solely to the trader who submitted the order to acknowledge receipt of the order and report whether it was matched, and the extent thereto, or rested. The response may further include a message to all market participants reporting a change in the order book due to the order. This response may take the form of a report of the specific change to the order book, e.g., an order for quantity X at price Y was added to the book (referred to, in one embodiment, as a Market By Order message), or may simply report the result, e.g., price level Y now has orders for a total quantity of Z (where Z is the sum of the previous resting quantity plus quantity X of the new order). In some cases, requests may elicit a non-impacting response, such as temporally proximate to the receipt of the request, and then cause a separate market-impact reflecting response at a later time. For example, a stop order, fill or kill order, also known as an immediate or cancel order, or other conditional request may not have an immediate market impacting effect, if at all, until the requisite conditions are met.

In one embodiment, the disclosed system may include a Market Segment Gateway (“MSG”) that is the point of ingress/entry and/or egress/departure for all transactions, i.e., the network traffic/packets containing the data therefore. The electronic trading system may include multiple MSGs, one for each market/product implemented thereby, where each MSG is specific to a single market at which the order of receipt of those transactions may be ascribed. Or, the electronic trading system may include one MSG for all the products implemented thereby. For example, a participant may send a request for a new transaction, e.g., a request for a new order, to the MSG. The MSG extracts or decodes the request message and determines the characteristics of the request message.

The MSG may include, or otherwise be coupled with, a buffer, cache, memory, database, content addressable memory, data store or other data storage mechanism, or combinations thereof, which stores data indicative of the characteristics of the request message. The request is passed to the transaction processing system, e.g., the match engine.

An MSG or Market Segment Gateway may be utilized for the purpose of deterministic operation of the market. Transactions for a particular market may be ultimately received at the electronic trading system via one or more points of entry, e.g., one or more communications interfaces, at which the disclosed embodiments apply determinism, which as described may be at the point where matching occurs, e.g., at each match engine (where there may be multiple match engines, each for a given product/market, or moved away from the point where matching occurs and closer to the point where the electronic trading system first becomes “aware” of the incoming transaction, such as the point where transaction messages, e.g., orders, ingress the electronic trading system. Generally, the terms “determinism” or “transactional determinism” may refer to the processing, or the appearance thereof, of orders in accordance with defined business rules. Accordingly, as used herein, the point of determinism may be the point at which the electronic trading system ascribes an ordering to incoming transactions/orders relative to other incoming transactions/orders such that the ordering may be factored into the subsequent processing, e.g., matching, of those transactions/orders as will be described. For more detail on deterministic operation in a trading system, see U.S. patent application Ser. No. 14/074,675, filed on Nov. 7, 2013, published as U.S. Patent Publication No. 2015/0127516, entitled “Transactionally Deterministic High Speed Financial Exchange Having Improved, Efficiency, Communication, Customization, Performance, Access, Trading Opportunities, Credit Controls, And Fault Tolerance”, the entirety of which is incorporated by reference herein and relied upon

Electronic trading of financial instruments, such as futures contracts, is conducted by market participants sending orders, such as to buy or sell one or more futures contracts, in electronic form to the exchange. These electronically submitted orders to buy and sell are then matched, if possible, by the exchange, i.e., by the exchange's matching engine, to execute a trade. Outstanding (unmatched, wholly unsatisfied/unfilled or partially satisfied/filled) orders are maintained in one or more data structures or databases referred to as “order books,” such orders being referred to as “resting,” and made visible, i.e., their availability for trading is advertised, to the market participants through electronic notifications/broadcasts, referred to as market data feeds. An order book is typically maintained for each product, e.g., instrument, traded on the electronic trading system and generally defines or otherwise represents the state of the market for that product, i.e., the current prices at which the market participants are willing buy or sell that product. As such, as used herein, an order book for a product may also be referred to as a market for that product.

In the exemplary embodiments, all transactions for a particular market may be ultimately received at the electronic trading system via one or more points of entry, e.g., one or more communications interfaces, at which the disclosed embodiments apply determinism, which as described may be at the point where matching occurs, e.g., at each match engine (where there may be multiple match engines, each for a given product/market, or moved away from the point where matching occurs and closer to the point where the electronic trading system first becomes “aware” of the incoming transaction, such as the point where transaction messages, e.g., orders, ingress the electronic trading system. Generally, the terms “determinism” or “transactional determinism” may refer to the processing, or the appearance thereof, of orders in accordance with defined business rules. Accordingly, as used herein, the point of determinism may be the point at which the electronic trading system ascribes an ordering to incoming transactions/orders relative to other incoming transactions/orders such that the ordering may be factored into the subsequent processing, e.g., matching, of those transactions/orders as will be described. For more detail on deterministic operation in a trading system, see U.S. patent application Ser. No. 14/074,675, filed on Nov. 7, 2013, published as U.S. Patent Publication No. 2015/0127516, entitled “Transactionally Deterministic High Speed Financial Exchange Having Improved, Efficiency, Communication, Customization, Performance, Access, Trading Opportunities, Credit Controls, And Fault Tolerance”, the entirety of which is incorporated by reference herein and relied upon.

Upon receipt of an incoming order to trade in a particular financial instrument, whether for a single-component financial instrument, e.g., a single futures contract, or for a multiple-component financial instrument, e.g., a combination contract such as a spread contract, a match engine, as described herein, will attempt to identify a previously received but unsatisfied order counter thereto, i.e., for the opposite transaction (buy or sell) in the same financial instrument at the same or better price (but not necessarily for the same quantity unless, for example, either order specifies a condition that it must be entirely filled or not at all). Previously received but unsatisfied orders, i.e., orders which either did not match with a counter order when they were received or their quantity was only partially satisfied, referred to as a partial fill, are maintained by the electronic trading system in an order book database/data structure to await the subsequent arrival of matching orders or the occurrence of other conditions which may cause the order to be modified or otherwise removed from the order book.

If the match engine identifies one or more suitable previously received but unsatisfied counter orders, they, and the incoming order, are matched to execute a trade there between to at least partially satisfy the quantities of one or both the incoming order or the identified orders. If there remains any residual unsatisfied quantity of the identified one or more orders, those orders are left on the order book with their remaining quantity to await a subsequent suitable counter order, i.e., to rest. If the match engine does not identify a suitable previously received but unsatisfied counter order, or the one or more identified suitable previously received but unsatisfied counter orders are for a lesser quantity than the incoming order, the incoming order is placed on the order book, referred to as “resting”, with original or remaining unsatisfied quantity, to await a subsequently received suitable order counter thereto. The match engine then generates match event data reflecting the result of this matching process. Other components of the electronic trading system, as will be described, then generate the respective order acknowledgment and market data messages and transmit those messages to the market participants.

Matching, which is a function typically performed by the exchange, is a process, for a given order which specifies a desire to buy or sell a quantity of a particular instrument at a particular price, of seeking/identifying one or more wholly or partially, with respect to quantity, satisfying counter orders thereto, e.g., a sell counter to an order to buy, or vice versa, for the same instrument at the same, or sometimes better, price (but not necessarily the same quantity), which are then paired for execution to complete a trade between the respective market participants (via the exchange) and at least partially satisfy the desired quantity of one or both of the order and/or the counter order, with any residual unsatisfied quantity left to await another suitable counter order, referred to as “resting.” A match event may occur, for example, when an aggressing order matches with a resting order. In one embodiment, two orders match because one order includes instructions for or specifies buying a quantity of a particular instrument at a particular price, and the other order includes instructions for or specifies selling a (different or same) quantity of the instrument at a same or better price.

The exchange computer system monitors incoming orders received thereby and attempts to identify, i.e., match or allocate, as described herein, one or more previously received, but not yet matched, orders, i.e., limit orders to buy or sell a given quantity at a given price, referred to as “resting” orders, stored in an order book database, wherein each identified order is contra to the incoming order and has a favorable price relative to the incoming order. An incoming order may be an “aggressor” order, i.e., a market order to sell a given quantity at whatever may be the current resting bid order price(s) or a market order to buy a given quantity at whatever may be the current resting ask order price(s). An incoming order may be a “market making” order, i.e., a market order to buy or sell at a price for which there are currently no resting orders. In particular, if the incoming order is a bid, i.e., an offer to buy, then the identified order(s) will be an ask, i.e., an offer to sell, at a price that is identical to or higher than the bid price. Similarly, if the incoming order is an ask, i.e., an offer to sell, the identified order(s) will be a bid, i.e., an offer to buy, at a price that is identical to or lower than the offer price.

An exchange computing system may receive conditional orders or messages for a data object, where the order may include two prices or values: a reference value and a stop value. A conditional order may be configured so that when a product represented by the data object trades at the reference price, the stop order is activated at the stop value. For example, if the exchange computing system's order management module includes a stop order with a stop price of 5 and a limit price of 1 for a product, and a trade at 5 (i.e., the stop price of the stop order) occurs, then the exchange computing system attempts to trade at 1 (i.e., the limit price of the stop order). In other words, a stop order is a conditional order to trade (or execute) at the limit price that is triggered (or elected) when a trade at the stop price occurs.

Stop orders also rest on, or are maintained in, an order book to monitor for a trade at the stop price, which triggers an attempted trade at the limit price. In some embodiments, a triggered limit price for a stop order may be treated as an incoming order.

Upon identification (matching) of a contra order(s), a minimum of the quantities associated with the identified order and the incoming order is matched and that quantity of each of the identified and incoming orders become two halves of a matched trade that is sent to a clearing house. The exchange computer system considers each identified order in this manner until either all of the identified orders have been considered or all of the quantity associated with the incoming order has been matched, i.e., the order has been filled. If any quantity of the incoming order remains, an entry may be created in the order book database and information regarding the incoming order is recorded therein, i.e., a resting order is placed on the order book for the remaining quantity to await a subsequent incoming order counter thereto.

It should be appreciated that in electronic trading systems implemented via an exchange computing system, a trade price (or match value) may differ from (i.e., be better for the submitter, e.g., lower than a submitted buy price or higher than a submitted sell price) the limit price that is submitted, e.g., a price included in an incoming message, or a triggered limit price from a stop order.

As used herein, “better” than a reference value means lower than the reference value if the transaction is a purchase transaction, and higher than the reference value if the transaction is a sell transaction. Said another way, for purchase transactions, lower values are better, and for relinquish or sell transactions, higher values are better.

Traders access the markets on a trading platform using trading software that receives and displays at least a portion of the order book for a market, i.e., at least a portion of the currently resting orders, enables a trader to provide parameters for an order for the product traded in the market, and transmits the order to the exchange computer system. The trading software typically includes a graphical user interface to display at least a price and quantity of some of the entries in the order book associated with the market. The number of entries of the order book displayed is generally preconfigured by the trading software, limited by the exchange computer system, or customized by the user. Some graphical user interfaces display order books of multiple markets of one or more trading platforms. The trader may be an individual who trades on his/her behalf, a broker trading on behalf of another person or entity, a group, or an entity. Furthermore, the trader may be a system that automatically generates and submits orders.

If the exchange computer system identifies that an incoming market order may be filled by a combination of multiple resting orders, e.g., the resting order at the best price only partially fills the incoming order, the exchange computer system may allocate the remaining quantity of the incoming, i.e., that which was not filled by the resting order at the best price, among such identified orders in accordance with prioritization and allocation rules/algorithms, referred to as “allocation algorithms” or “matching algorithms,” as, for example, may be defined in the specification of the particular financial product or defined by the exchange for multiple financial products. Similarly, if the exchange computer system identifies multiple orders contra to the incoming limit order and that have an identical price which is favorable to the price of the incoming order, i.e., the price is equal to or better, e.g., lower if the incoming order is a buy (or instruction to purchase) or higher if the incoming order is a sell (or instruction to relinquish), than the price of the incoming order, the exchange computer system may allocate the quantity of the incoming order among such identified orders in accordance with the matching algorithms as, for example, may be defined in the specification of the particular financial product or defined by the exchange for multiple financial products.

An exchange must respond to inputs, such as trader orders, cancellation, etc., in a manner as expected by the market participants, such as based on market data, e.g., prices, available counter-orders, etc., to provide an expected level of certainty that transactions will occur in a consistent and predictable manner and without unknown or unascertainable risks. Accordingly, the method by which incoming orders are matched with resting orders must be defined so that market participants have an expectation of what the result will be when they place an order or have resting orders and an incoming order is received, even if the expected result is, in fact, at least partially unpredictable due to some component of the process being random or arbitrary or due to market participants having imperfect or less than all information, e.g., unknown position of an order in an order book. Typically, the exchange defines the matching/allocation algorithm that will be used for a particular financial product, with or without input from the market participants. Once defined for a particular product, the matching/allocation algorithm is typically not altered, except in limited circumstance, such as to correct errors or improve operation, so as not to disrupt trader expectations. It will be appreciated that different products offered by a particular exchange may use different matching algorithms.

Traders trading on an exchange including, for example, exchange computer system 100, often desire to trade multiple financial instruments in combination. Each component of the combination may be called a leg. Traders can submit orders for individual legs or in some cases can submit a single order for multiple financial instruments in an exchange-defined combination. Such orders may be called a strategy order, a spread order, or a variety of other names.

A spread instrument may involve the simultaneous purchase of one security and sale of a related security, called legs, as a unit. The legs of a spread instrument may be options or futures contracts, or combinations of the two. Trades in spread instruments are executed to yield an overall net position whose value, called the spread, depends on the difference between the prices of the legs. Spread instruments may be traded in an attempt to profit from the widening or narrowing of the spread, rather than from movement in the prices of the legs directly. Spread instruments are either “bought” or “sold” depending on whether the trade will profit from the widening or narrowing of the spread, respectively. An exchange often supports trading of common spreads as a unit rather than as individual legs, thus ensuring simultaneous execution of the two legs, eliminating the execution risk of one leg executing but the other failing.

One example of a spread instrument is a calendar spread instrument. The legs of a calendar spread instrument differ in delivery date of the underlier. The leg with the earlier occurring delivery date is often referred to as the lead month contract. A leg with a later occurring delivery date is often referred to as a deferred month contract. Another example of a spread instrument is a butterfly spread instrument, which includes three legs having different delivery dates. The delivery dates of the legs may be equidistant to each other. The counterparty orders that are matched against such a combination order may be individual, “outright” orders or may be part of other combination orders.

In other words, an exchange may receive, and hold or let rest on the books, outright orders for individual contracts as well as outright orders for spreads associated with the individual contracts. An outright order (for either a contract or for a spread) may include an outright bid or an outright offer, although some outright orders may bundle many bids or offers into one message (often called a mass quote).

A spread is an order for the price difference between two contracts. This results in the trader holding a long and a short position in two or more related futures or options on futures contracts, with the objective of profiting from a change in the price relationship. A typical spread product includes multiple legs, each of which may include one or more underlying financial instruments. A butterfly spread product, for example, may include three legs. The first leg may consist of buying a first contract. The second leg may consist of selling two of a second contract. The third leg may consist of buying a third contract. The price of a butterfly spread product may be calculated as:

Butterfly=Leg1−2×Leg2+Leg3 (equation 1)

In the above equation, Leg1 equals the price of the first contract, Leg2 equals the price of the second contract and Leg3 equals the price of the third contract. Thus, a butterfly spread could be assembled from two inter-delivery spreads in opposite directions with the center delivery month common to both spreads.

A calendar spread, also called an intra-commodity spread, for futures is an order for the simultaneous purchase and sale of the same futures contract in different contract months (i.e., buying a September CME S&P 500® futures contract and selling a December CME S&P 500 futures contract).

A crush spread is an order, usually in the soybean futures market, for the simultaneous purchase of soybean futures and the sale of soybean meal and soybean oil futures to establish a processing margin. A crack spread is an order for a specific spread trade involving simultaneously buying and selling contracts in crude oil and one or more derivative products, typically gasoline and heating oil. Oil refineries may trade a crack spread to hedge the price risk of their operations, while speculators attempt to profit from a change in the oil/gasoline price differential.

A straddle is an order for the purchase or sale of an equal number of puts and calls, with the same strike price and expiration dates. A long straddle is a straddle in which a long position is taken in both a put and a call option. A short straddle is a straddle in which a short position is taken in both a put and a call option. A strangle is an order for the purchase of a put and a call, in which the options have the same expiration and the put strike is lower than the call strike, called a long strangle. A strangle may also be the sale of a put and a call, in which the options have the same expiration and the put strike is lower than the call strike, called a short strangle. A pack is an order for the simultaneous purchase or sale of an equally weighted, consecutive series of four futures contracts, quoted on an average net change basis from the previous day's settlement price. Packs provide a readily available, widely accepted method for executing multiple futures contracts with a single transaction. A bundle is an order for the simultaneous sale or purchase of one each of a series of consecutive futures contracts. Bundles provide a readily available, widely accepted method for executing multiple futures contracts with a single transaction.

Thus an exchange may match outright orders, such as individual contracts or spread orders (which as discussed herein could include multiple individual contracts). The exchange may also imply orders from outright orders. For example, exchange computer system 100 may derive, identify and/or advertise, publish, display or otherwise make available for trading orders based on outright orders.

For example, two different outright orders may be resting on the books, or be available to trade or match. The orders may be resting because there are no outright orders that match the resting orders. Thus, each of the orders may wait or rest on the books until an appropriate outright counteroffer comes into the exchange or is placed by a user of the exchange. The orders may be for two different contracts that only differ in delivery dates. It should be appreciated that such orders could be represented as a calendar spread order. Instead of waiting for two appropriate outright orders to be placed that would match the two existing or resting orders, the exchange computer system may identify a hypothetical spread order that, if entered into the system as a tradable spread order, would allow the exchange computer system to match the two outright orders. The exchange may thus advertise or make available a spread order to users of the exchange system that, if matched with a tradable spread order, would allow the exchange to also match the two resting orders. Thus, the match engine is configured to detect that the two resting orders may be combined into an order in the spread instrument and accordingly creates an implied order.

In other words, the exchange's matching system may imply the counteroffer order by using multiple orders to create the counteroffer order. Examples of spreads include implied IN, implied OUT, 2nd- or multiple-generation, crack spreads, straddle, strangle, butterfly, and pack spreads. Implied IN spread orders are derived from existing outright orders in individual legs. Implied OUT outright orders are derived from a combination of an existing spread order and an existing outright order in one of the individual underlying legs. Implied orders can fill in gaps in the market and allow spreads and outright futures traders to trade in a product where there would otherwise have been little or no available bids and asks.

For example, implied IN spreads may be created from existing outright orders in individual contracts where an outright order in a spread can be matched with other outright orders in the spread or with a combination of orders in the legs of the spread. An implied OUT spread may be created from the combination of an existing outright order in a spread and an existing outright order in one of the individual underlying leg. An implied IN or implied OUT spread may be created when an electronic match system simultaneously works synthetic spread orders in spread markets and synthetic orders in the individual leg markets without the risk to the trader/broker of being double filled or filled on one leg and not on the other leg.

By linking the spread and outright markets, implied spread trading increases market liquidity. For example, a buy in one contract month and an offer in another contract month in the same futures contract can create an implied market in the corresponding calendar spread. An exchange may match an order for a spread product with another order for the spread product. Some existing exchanges attempt to match orders for spread products with multiple orders for legs of the spread products. With such systems, every spread product contract is broken down into a collection of legs and an attempt is made to match orders for the legs. Examples of implied spread trading include those disclosed in U.S. Patent Publication No. 2005/0203826, entitled “Implied Spread Trading System,” the entire disclosure of which is incorporated by reference herein and relied upon. Examples of implied markets include those disclosed in U.S. Pat. No. 7,039,610, entitled “Implied Market Trading System,” the entire disclosure of which is incorporated by reference herein and relied upon.

As an intermediary to electronic trading transactions, the exchange bears a certain amount of risk in each transaction that takes place. To that end, the clearing house implements risk management mechanisms to protect the exchange. One or more of the modules of the exchange computer system 100 may be configured to determine settlement prices for constituent contracts, such as deferred month contracts, of spread instruments, such as for example, settlement module 142.

One or more of the above-described modules of the exchange computer system 100 may be used to gather or obtain data to support the settlement price determination, as well as a subsequent margin requirement determination. For example, the order book module 110 and/or the market data module 112 may be used to receive, access, or otherwise obtain market data, such as bid-offer values of orders currently on the order books. The trade database 108 may be used to receive, access, or otherwise obtain trade data indicative of the prices and volumes of trades that were recently executed in a number of markets. In some cases, transaction data (and/or bid/ask data) may be gathered or obtained from open outcry pits and/or other sources and incorporated into the trade and market data from the electronic trading system(s).

In some cases, the outright market for the deferred month or other constituent contract may not be sufficiently active to provide market data (e.g., bid-offer data) and/or trade data. Spread instruments involving such contracts may nonetheless be made available by the exchange. The market data from the spread instruments may then be used to determine a settlement price for the constituent contract. The settlement price may be determined, for example, through a boundary constraint-based technique based on the market data (e.g., bid-offer data) for the spread instrument, as described in U.S. Patent Publication No. 2015/0073962 entitled “Boundary Constraint-Based Settlement in Spread Markets” (“the '962 Publication”), the entire disclosure of which is incorporated by reference herein and relied upon. The '962 Publication considers all spreads, or composite object data, where the composite object specifically includes the contract being settled, e.g., the target object. Settlement price determination techniques may be implemented to cover calendar month spread instruments having different deferred month contracts.

Referring again to data transaction processing systems, a system may depend on certain rules, logic, and inter-related objects and data. In technical and computing environments, a system may calculate values for multiple objects subject to rules, e.g., business or environment logic, associated with the objects. Certain object types may also depend on other object types. For example, a computing environment may include multiple objects of different types, e.g., base objects and composite objects. A composite object as used herein is an object whose value depends on, is related to, or is influenced by, the values of other objects, such as base objects or other composite objects. For example, a composite object may involve transactions between multiple, e.g., two, base objects. Or, a composite object may define a relationship between other objects. Thus, composite objects depend on the values of other system objects. In one embodiment, a composite object involves or defines a transaction or relationship between at least two other objects. For example, a composite object involves or defines a transaction or relationship between two base objects.

The range reduction module, in one application, can rapidly and efficiently determine solutions, or a range of solutions, for a target object, where the range meets, or attempts to meet, predetermined rules and conforms to, or attempts to conform to, transaction requests associated with received values for other objects. Predetermined rules may be programmed into the computer. An example predetermined rule may be a rule about the difference in values, e.g., the net value, between contracts. The rules may be hard rules, or system requirements. Alternatively, rules may be soft rules that are not requirements but reflect system or user preferences.

For example, the disclosed embodiments may optimize the values of a target base object by considering the effects of that target object's values on other all other objects associated with the same product, including composite objects that are related to the base objects. Moreover, the system environment may impose restrictions on the values of the composite objects. For example, the system may impose certain performance requirements on composite objects. Or, the system may impose a minimum or maximum value for a composite object value that is based on at least two base objects' values. Thus, the system attempts to select base object values or range of values that conform to the composite object value requirement, transaction requests, and received data. In such a computing environment, it may be desirable to optimize overall system behavior by assigning values to objects such that rules or relationships involving the objects, e.g., composite object definitions, are met.

In one embodiment, the computing may receive values for base objects and composite objects, and the computing system attempts to select values in accordance with relationships associated with the base objects and composite objects. In particular, the system may receive high and low values for each base and composite object. Even though a composite object may define a relationship between base objects, or be related to the base objects, the values received for the composite objects may be independent of the values received for the corresponding base objects, e.g., fluctuations in the values of the corresponding base objects may have no effect on the values received for the composite object, and vice versa.

In one embodiment, the composite object values define a range of values that is then compared to the transaction results involving two base objects, discussed in further detail herein.

In one embodiment, the disclosed embodiments provide systems and methods for efficiently selecting values for or assigning values to a target objects based on the received values. In one embodiment, the disclosed embodiments may utilize composite objects associated with a target object as a guide to select values for the target object.

It should be appreciated that the received values for a target object may be considered to be subjective values for target object, or based on users' perception of the base objects. However, the received values may define a broad range, with no guidance as to which of the value in the range should be selected as the final value for the target object.

The system in one embodiment uses information from all of the other objects in the database related to the target object to minimize the range of possible values of the target object. In one embodiment, the minimized range points to a small finite number of values, e.g., one, that should be selected as the final value for the target object.

In other words, the system generates a small range of multiple subjective values for a target object and then selects, or enables selection of, a value from the reduced range. Said yet another way, the system attempts to select one of many possible values for an object and assigns the single selected value of the object as the final value for that object. Thus the disclosed embodiments can be applied in any system needing to decide which of multiple possible options or values should be selected as the definitive option or value, where the decision is guided by the system's environment and transaction requests, which include value data, for other objects in the system that are related to the objects in question.

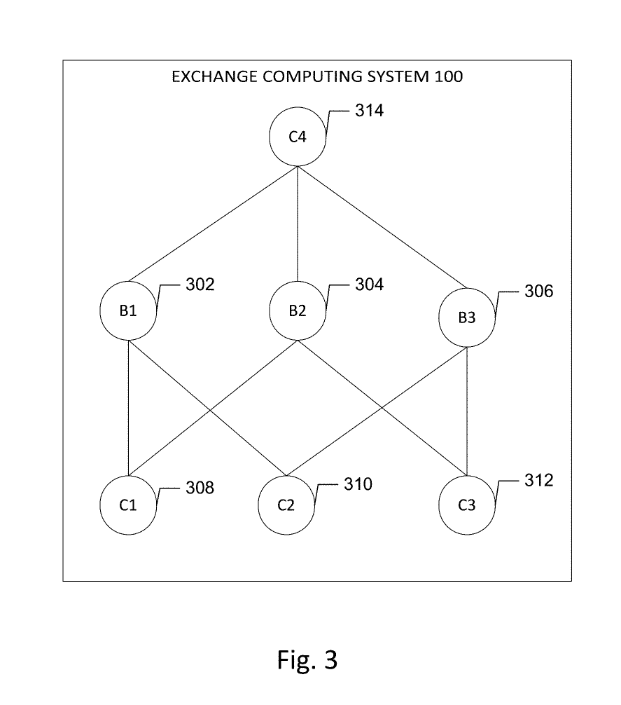

For example, as shown in FIG. 3, a computing system 100 may include several base objects and composite objects, such as base objects B1 302, B2 304 and B3 306 and composite objects C1 308, C2 310, C3 312 and C4 314. Each composite object may be associated with two or more base objects. For example, as also shown in FIG. 3, C1 may be associated with B1 and B2, C2 may be associated with B1 and B3, C3 may be associated with B2 and B3, and C4 may be associated with B1, B2 and B3.

Although three base objects and four composite objects are illustrated in FIG. 3, the exchange computing system may include many more base and composite objects. In one embodiment, the number of composite objects is at least one more than the number of base objects, and at least one of the composite objects defines a relationship between all of the base objects.

Moreover, an object may be considered to be simultaneously both a base object and a composite object. For example, an object may both (i) depend upon other objects (and thus be considered a composite object) and (ii) be depended upon by other objects (and thus be considered a base object). It should be appreciated that whether an object is characterized as a base object or a composite object depends upon the relationship of that object with other objects in the computing system.

In one embodiment, the system may store the relationships between composite objects and base objects as equations. For example, if composite object C1 defines the net value of base objects B1 and B2, then the following equation 1 defines C1 in terms of B1 and B2:

C1=B1−B2 Equation 1:

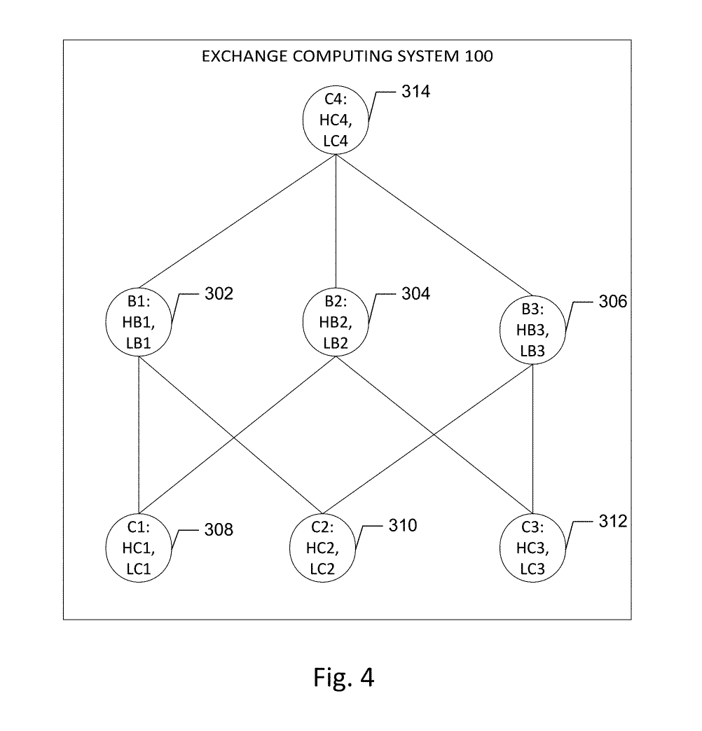

The computing system or range reduction module may receive values for each of the objects. For example, as shown in FIG. 4, the exchange computing system may receive and store two values, high value HB1 and low value LB1, for base object B1, high value HB2 and low value LB2 for base object B2, and high value HB3 and low value LB3 for base object B3. The computing system or range reduction module may also receive and store high value HC1 and low value LC1 for composite object C1, high value HC2 and low value LC2 for composite object C2, high value HC3 and low value LC3 for composite object C3, and high value HC4 and low value LC4 for composite object C4. Thus each object may be associated with a plurality of values.

It should be appreciated that even if a composite object is associated with multiple base objects, the values received for the composite object are independent of the values received of the corresponding base objects. For example, the received values for each of C1, B1 and B2 are independent of the above equation 1. In other words, the received values for C1 are not calculated based on B1 and B2. In a financial exchange computer system, the received values may instead be based on, for example, market factors, trade data, user behavior or user predictions. Thus, it may not be the case that each value received for C1, B1 and B2 conforms to equation 1.

For example, different traders may submit values to the exchange computing system for each of C1, B1, and B2 in Equation 1. The exchange computing system may receive values for some or all of C1, B1 and B2. If, however, the exchange computing system only receives values from users for C1 and B1, equation 1 can be used to compute the value of B2.

Thus, values received by the exchange computing system for various data objects processed by the exchange computing system may be considered to be subjective values, because they may be submitted by users' individual opinion, e.g., subjective, of the value of an object. The exchange computing system attempts to use received data to arrive at, or settle at, a value for an object based on received data. Thus, the exchange computing system may be considered to be computing an objective value based on received (e.g., subjective) data. By computing a value for an object that is consistent with other received data, transaction requests associated with the other received data can remain valid, e.g., the performance of the transaction requests does not become impossible.

Although each base and composite object in the examples of FIGS. 3 and 4 received two possible values, e.g., a high value and a low value, each object may receive more than two values. Or, the computing system might calculate additional values that could be possible values for objects. For example, in some computing environments, the received values would be understood to define a range, and the computing system may generate additional values as possible object values between the received values. For example, the computing system may generate a median value between the received high and low values. In one embodiment, the full list of high, median and low values may be considered to be the received values.

For example, a product may include several quarterly contracts that differ only in delivery date. For example, a Eurodollar futures contract offered by the CME may include forty quarterly contracts, e.g., March, June, September and December, for ten years, e.g., the next ten years, e.g., 2016 to 2026. Each contract is a Eurodollar futures contract that has a delivery date of one of March, June, September or December in one of ten years. The exchange may receive outright orders for any one of the forty contracts. Each of these futures contracts may be represented as a base object in the exchange computing system or environment.

The exchange may also receive orders for calendar spread instruments between any two of the forty contracts. The calendar spread orders may be represented as composite objects in the exchange computing system or environment.

The exchange may also receive outright orders for butterfly spread orders between any three of the forty contracts. The butterfly spread orders may likewise be represented as composite objects in the exchange computing system or environment. It should be appreciated that the exchange calculates implied contract and spread values for contracts and spreads offered or traded on the exchange.

Thus, the exchange offers multiple contract or outright instruments that differ only in delivery dates, e.g., 40 Eurodollar contracts that are identical except for delivery dates, calendar spread instruments for a variety of pairs of the contracts, and butterfly spreads for a variety of triplets of the contracts. In addition, each contract or outright instrument, calendar spread instrument, and butterfly spread instrument may have multiple possible values, or prices that are valid for the market for that respective instrument. In one embodiment, each instrument offered can have at least two possible values that are valid for the respective instrument, namely, the tradable bid and the tradable ask.

For example, a financial instrument may include several contracts, each having an outright market bid and offer. The contracts may be quoted in price increments called ticks. The bid and offer may be separated by multiple, e.g., three, ticks. Any of the ticks that are between the market bid and offer, including the bid and offer, may be valid settlement prices for the contract. Any of these ticks may thus be selected by the exchange as a settlement price for the contract. For example, a contract having a 45 bid and a 50 offer quoted in 1 unit increments, or ticks, could settle at 45, 46, 47, 48, 49 or 50 without violating the market. Thus, the exchange could select to settle the price for that contract at any of these prices, and each of these would be considered valid, as that term is used herein. Or, the bid and offer may be exactly one tick apart, meaning that the exchange could select either the bid or the offer as the settlement price and have selected valid prices for the contract, but there are no ticks between the bid and the offer that can be selected.

Settlement prices selected for two related contracts, e.g., December 2015 and March 2016 Eurodollar contracts, may or may not be valid for the tradable Eurodollar calendar spread instrument between December 2015 and March 2016, depending on the value of the tradable Eurodollar calendar spread instrument between December 2015 and March 2016. Similarly, settlement prices selected for three related contracts, e.g., December 2015, March 2016 and June 2016 Eurodollar contracts, may or may not be valid for a tradable butterfly spread instrument between December 2015, March 2016 and June 2016, depending on the value of the tradable butterfly spread instrument between December 2015, March 2016 and June 2016.

As discussed above, several prices or values may be considered to be valid for a tradable market. For example, for a given market, the tradable bid, the tradable offer, and any ticks between the tradable bid and offer may be possible values for that market. Thus, an exchange may be able to select any one of those values as the settlement price for a given contract, where each value is valid for the outright market for that contract.

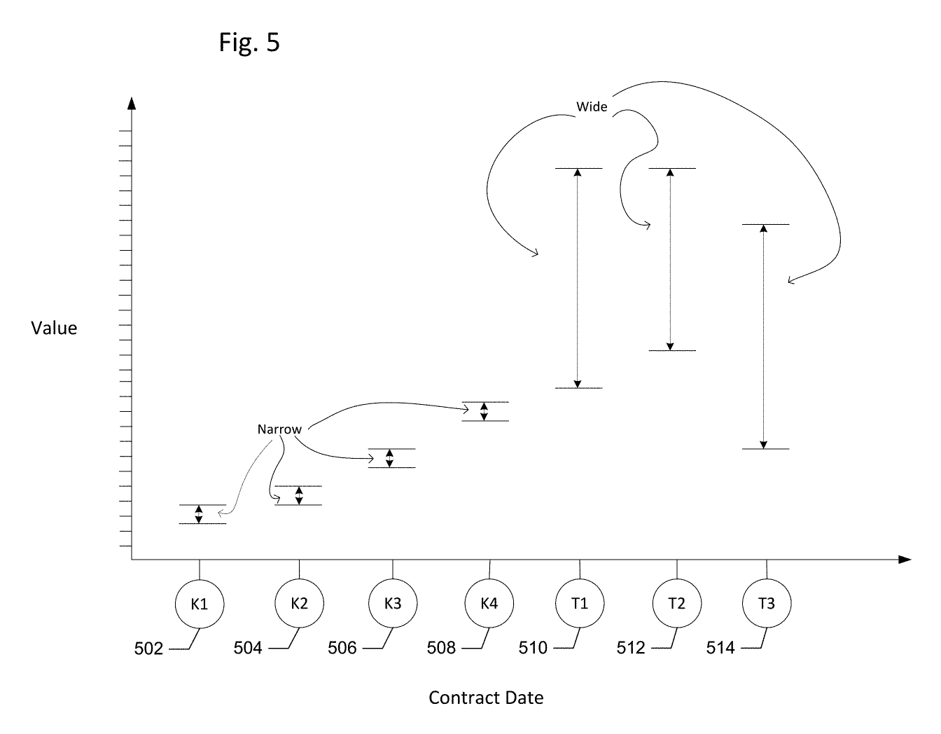

As discussed above, an exchange computing system may receive data via electronic data transaction request messages regarding objects traded within the exchange computing system. For example, as shown in FIG. 5, the exchange computing system may trade objects K1 502, K2 504, K3 506, K4 508, T1 510, T2 512, and T3 514. Each of objects K1, K2, K3, K4, T1, T2, and T3 may relate to a different month, or different contract, for the same underlying product. In other words, objects K1, K2, K3, K4, T1, T2, and T3 may all be based on a financial instrument that only differs in the delivery date of the financial instrument.

The data received from users for any of the months can be used to settle the value for the month. For some months, such as the earlier months (e.g., closer to the intersection of the x and y axes) K1, K2, K3 and K4, the exchange computing system may receive data that defines a relatively narrow range of values. Thus, settling on a final value for months or objects K1, K2, K3 and K4 may be easy and uncontroversial. For example, due to the narrow range of values received for K1, there may be only a few possible values for K1.

In one example, a narrow range may mean that there can only be one possible value for an object. Or, a narrow range may mean that the range is equal to or less than a specific number of ticks. It should be appreciated that an administrator or user of a data transaction processing system can specify or configure a range that should be interpreted as or considered to be a narrow range. The system may accordingly allow selection of the size of a range that constitutes a known value, or what constitutes a narrow range, and what constitutes a wide range.

The values for objects beginning with a K in FIG. 5 may be considered to be known values, because, for example, the range of data received for such objects is narrow.

Other objects, such as T1, T2 and T3, may have received a wide range of data, such that it is difficult or illogical to determine a final settlement price for these objects. Again, a user or administrator may be able to specify or define a range of values that constitutes a wide range. It would be desirable to optimize the wide range associated with target objects T1, T2 and T3, so that the exchange computing system can ensure that whatever value is selected for these objects, transaction requests associated with other related data, such as values for composite objects related to the target objects, do not become impossible to perform, or invalid.

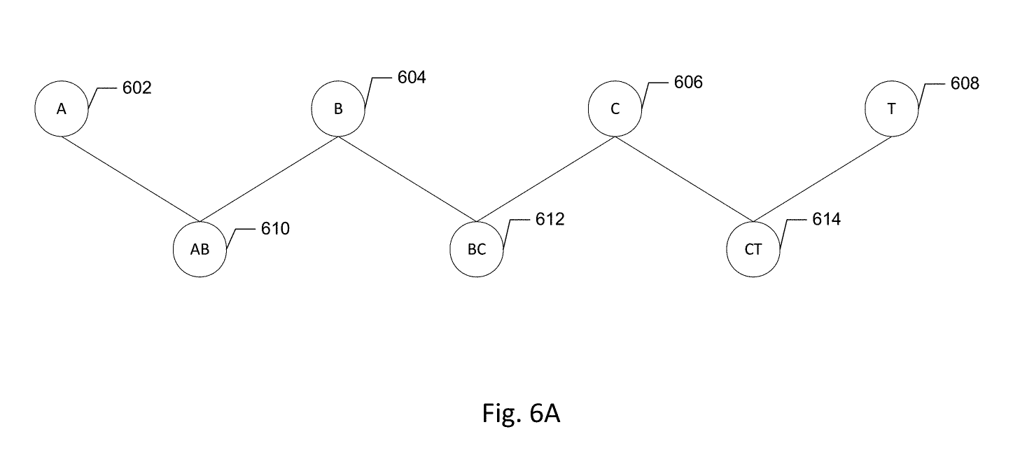

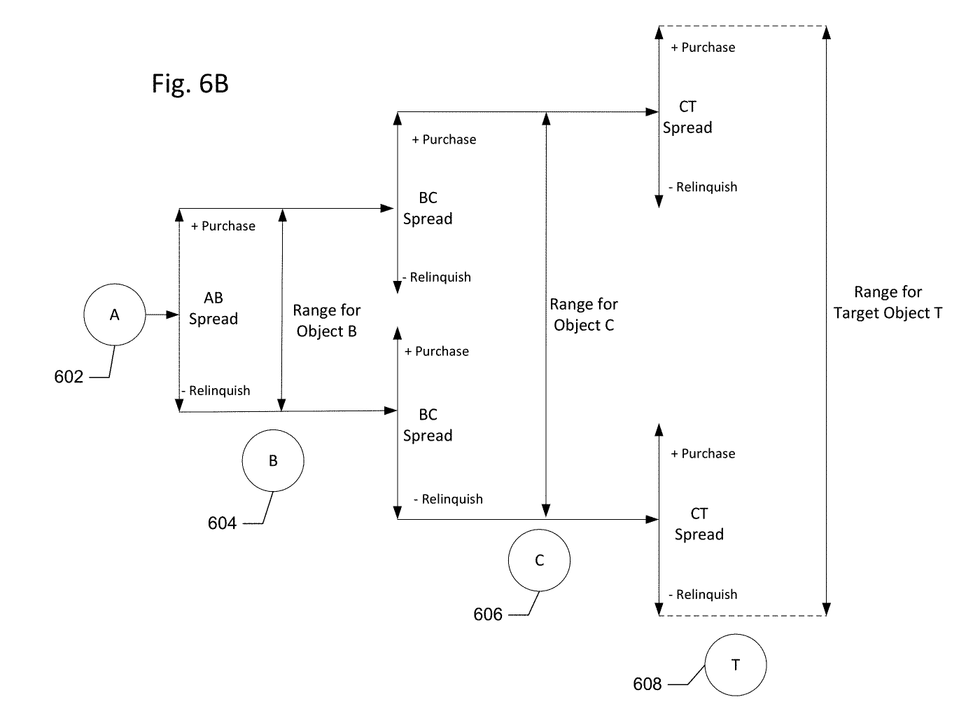

Referring now to FIG. 6A, objects A 602, B 604, C 606 and T 608 are different data objects for a product. Object A 602 is a known object, i.e., has received values that define a narrow range of values, such that the final settlement value of A can be considered to be known. Target object T 608 has received a wide range of values that do not all lead to a specific value, and thus the target object T is said to be unknown. The range reduction system identifies a route between known object A and target object T. Objects B 604 and C 606 may be other known or unknown objects, but in the example of FIG. 6A, the system begins with known object A to find a path to target object T. In particular, the system identifies composite object AB 610 that defines a relationship between objects A and B, composite object BC 612 that defines a relationship between objects B and C, and composite object CT 614 that defines a relationship between objects C and T.

The range reduction system in one embodiment only considers paths between objects if the data transaction processing system has received data from users about a composite object including the objects. In the example of FIG. 6A, the data transaction processing system has received data for composite objects AB 610, BC 612 and CT 614.

In some of the disclosed embodiments, the data received for composite objects may define a transaction between the constituent base objects, or the base objects associated with the composite object. For example, composite object AB is associated with base object A and B, and base objects A and B are accordingly constituent base objects of composite object AB. The transaction may either be to purchase a financial instrument representing the difference between the base objects, or relinquish a financial instrument representing the difference between the base objects. The system only identifies a composite object as contributing to an overall route between a known base object and a target base object if the system has received data for the composite object. For example, in FIG. 6A, the system may have received data for composite objects AB, BC and CT. Thus, these composite objects (and particularly, the bid ask spread associated with these objects) are used by the data transaction processing system to create a route from A to T, as shown in FIG. 6A.

As shown in FIG. 6B, each composite object may be used to create or increase a range of values for the target object. In particular, the system begins with the known object A, and uses AB composite object data to build a range of possible values for B. In other words, the AB spread is applied to the known value of A to generate a range for B. Then, BC composite object data, or the BC spread, is applied to the endpoints of the range for B to generate a range for C. It should be appreciated that the range for C is equal to or greater than the range for B. Because each composite object is used to build or expand the range for the subsequent object, the range for each subsequent object is always greater than or equal to the range for the previous object. The CT spread data is then applied to the endpoints of the range for T to generate a range for target object T. The system thus generates a range for target object T based on the route A-B-C-T. Again, this route is identified by the system as a viable route from known object A to target object T because the system has received composite object data for each composite object between each base object in the route, namely, the system has received AB data, BC data, and CT data.

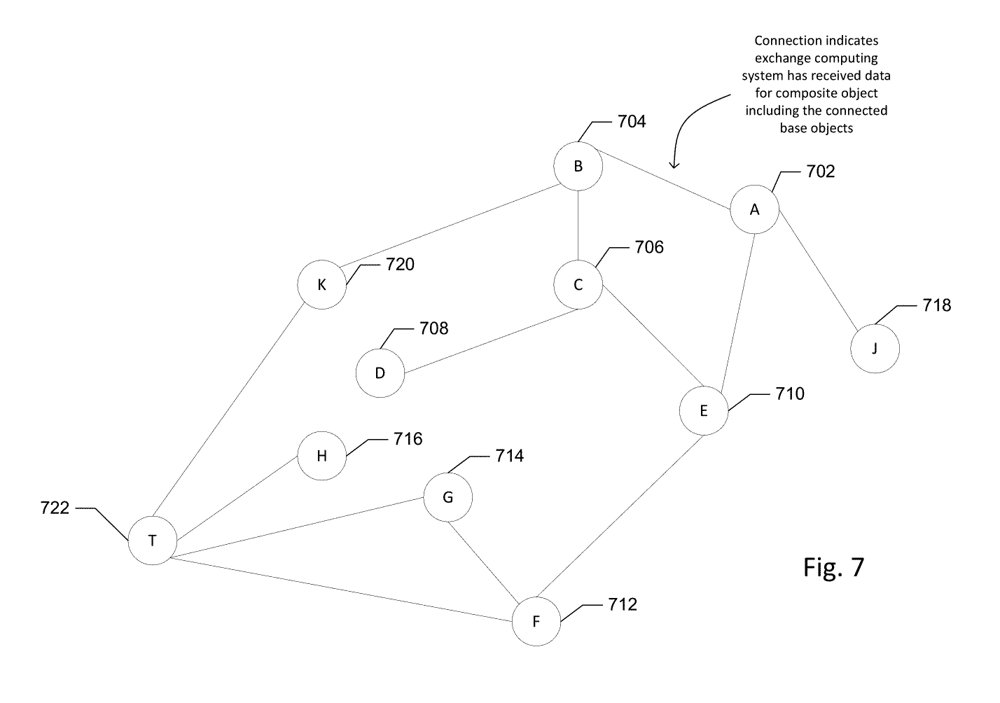

FIG. 7 illustrates a node graph of base objects A 702, B 704, C 706, D 708, E 710, F 712, G 714, H 716, J 718, K 720 and T 722. A connection illustrated between nodes/objects indicates that the exchange computing system has received data for the composite object defined by the base objects that are connected. For example, in FIG. 7, the connection between base object A and base object B indicates that the system has received data for the AB composite object. If A is the known object (e.g., its final settlement value has been determined, or can be determined) and T is the target object (e.g., it is desirable to narrow the range for T), the system identifies all possible routes from A to T where, for each pair of base objects defining a portion of the route, the system has received data for the composite object related to the pair of base objects. The system then identifies a range for a target object based on each route as described herein.

The system may use known algorithms such as a breadth-first search (BFS) or a depth-first search (DFS) for traversing the node graph. As is known, when a BFS algorithm is implemented, the system begins at the tree root (or some arbitrary node of a graph) and explores the neighbor nodes first, before moving to the next level neighbors. And, when a DFS algorithm is implemented, the system begins at the root (selecting some arbitrary node as the root in the case of a graph) and explores as far as possible along each branch before backtracking. Compared to BFS or DFS algorithms, the disclosed range reduction system associates and stores two values for each path that is identified between nodes, or base objects. Each set of two values defines a spread for a transaction between the two corresponding nodes. Moreover, each subsequent node pair that is considered may increase the overall range for the target object broader. In addition, the range reduction system selects the best upper and lower bounds from all of the identified route ranges to generate a new range for the target object. The selected upper and lower bounds may not be derived from the same route range. Thus, the disclosed range reduction system relates to a specific, discrete way to locate all routes between objects and associate values with each object pair defining a portion of the route.

The system may determine all known routes by first identifying whether the system has received data for composite objects associated with the known base object. As described in more detail below, each identified path between two base objects is associated with two values (e.g., a spread range or a bid-ask range), and both values are used to modify the target object's target range. The disclosed embodiments are a specific, discrete implementation of finding all routes between nodes and determining values for a target object based on the identified routes, where each portion between two nodes (e.g., due to a composite object associated with the two nodes) increases or can increase (but can never decrease) the overall range of the target object.

For example, referring to FIG. 7, where A is a base object with a known settlement value, the system identifies A-B, A-E and A-J as composite objects that include A as a constituent base object and are associated with received data. Thus, these composite objects are considered to be possible portions of routes between A and T. In contrast, A-C has not received bid/ask data (e.g., from users of the exchange computing system) and is not accordingly illustrated with a line connecting A to C.

Upon identifying A-B, A-E and A-J as composite objects that include A as a constituent base object and are associated with received data, for each of those composite objects, the system analyzes each of the base objects other than A, namely, B for composite object A-B, E for composite object A-E, and J for composite object A-J.

Analyzing B first, the system identifies whether the system has received data for composite objects associated with B that have not yet been considered (such as A-B), and identifies B-K and B-C. Thus, the system identifies B-K and B-C as composite objects that include B as a constituent base object and are associated with received data. For each of those composite objects, the system analyzes each of the base objects other than B, namely, K for composite object B-K and C for composite object B-C.

The system then identifies whether the system has received data for composite objects associated with K that have not yet been analyzed already or considered (such as B-K), and identifies K-T. The system recognizes that T is the target object, and then builds a route based on base objects that were along the identified path. For instance, upon identifying partial route K-T, the system pieces together K-T, B-K, and A-B to arrive at the full route A-B-K-T between A and T. The system returns to B and any unanalyzed objects, and identifies that it still needs to analyze base object C via composite object B-C. Because C is connected to D (e.g., due to having received composite object data for CD), but D is not connected to any other node or object, no new routes are added.

If the system has not received data for a given composite object, then the constituent base objects (e.g., the base objects associated with the given composite object) are not part of a route identified by the system to use to determine a range for a target object.

In this fashion, the system identifies, in addition to route A-B-K-T, routes A-B-C-E-F-T, A-B-C-E-F-G T, A-E-F-T, and A-E-F-G-T as routes from A to T. The system then identifies a range for T based on each route as described herein.

For example, for route A-B-K-T, the range reduction system begins with the known value of A, applies the AB spread to A to generate a range of values for B, applies the BK spread to the B range to generate a range of values for K, and applies the KT spread to the K range to generate a range of values for target object T.

For route A-B-C-E-F-T, the range reduction system begins with the known value of A, applies the AB spread to A to generate a range of values for B, applies the BC spread to the B range to generate a range of values for C, applies the CE spread to the C range to generate a range of values for E, applies the EF spread to the E range to generate a range of values for F, and applies the FT spread to the F range to generate a range of values for target object T.

For route A-B-C-E-F-G-T, the range reduction system begins with the known value of A, applies the AB spread to A to generate a range of values for B, applies the BC spread to the B range to generate a range of values for C, applies the CE spread to the C range to generate a range of values for E, applies the EF spread to the E range to generate a range of values for F, applies the FG spread to the F range to generate a range of values for G, and applies the GT spread to the G range to generate a range of values for target object T.

For route A-E-F-T, the range reduction system begins with the known value of A, applies the AE spread to A to generate a range of values for E, applies the EF spread to the E range to generate a range of values for F, and applies the FT spread to the F range to generate a range of values for target object T.

For route A-E-F-G-T, the range reduction system begins with the known value of A, applies the AE spread to A to generate a range of values for E, applies the EF spread to the E range to generate a range of values for F, applies the FG spread to the F range to generate a range of values for G, and applies the GT spread to the G range to generate a range of values for target object T.

The system then compares the various ranges received for target object T. In particular, the system analyzes the upper and lower bounds of the ranges of all the identified routes. The system may identify how many different routes lead to a particular value for the upper and lower bounds.

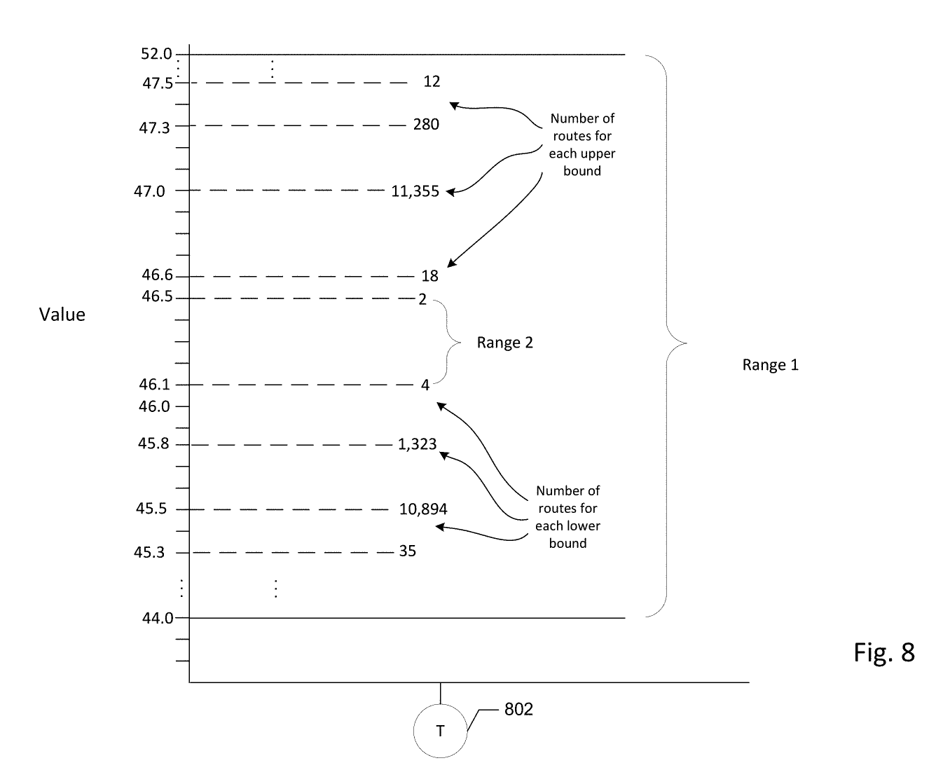

For example, as shown in FIG. 8, the system may plot ranges associated with a target object T 802. The values illustrated in the y-axis are different values that may be selected as a final settlement value for target object T. Range 1, which is defined by values included in transaction requests to buy or sell units of target object T, spans from a low value of 44.0 (e.g., the highest or best bid price received by the system for target object T) to a high value of 52.0 (e.g., the lowest or best ask price received by the system for target object T). Range 1 may be defined by the best bid and best ask from the received data for target object T, namely, 44 to 52. In other words, 44 may be the highest bid price for target object T, and 52 may the lowest sell price for target object T received from users of the exchange.

However, 44 to 52 may be considered to be a wide range, such that it is not sufficiently narrow to select a final settlement value for target object T. Prior art systems may simply average 44 and 52 to arrive at a settlement price of 48. Or, prior art systems may associate all prices between 44 and 52, namely 44.1, 44.2, 44.3, . . . , 51.7, 51.8, 51.9 and 52.0 changing in 0.1 price increments (assuming 0.1 tick size, as defined above), with target object T. Selecting a settlement price of 48 may be incompatible with, or render impossible, other received orders, as discussed herein. Moreover, storing a large data set, such as 44.1, 44.2, 44.3, . . . , 51.7, 51.8, 51.9 and 52.0 changing in 0.1 price increments, for target object T may be an inefficient use of memory, storage space, and computing resources. In a system including many target objects, each target object may become associated with a wide range of possible values based on transaction requests received by the exchange computing system for those target objects.

A route may be represented within a computing system as a data set, where each object in the data set defines the route. For example, an exchange computing system may store route A-B-C-T as a data set [A, B, C, T].

The range reduction system identifies each route between each known object and the target object, and then identifies the range for target object T based on each route. The best range for target object T is defined by the best bid (purchase) and ask (relinquish) associated with any of the routes. In other words, the range for target object T in FIG. 6B is based only on route A-B-C-T. Other routes between A and T may also be identified by the range reduction system, and for each identified route, the range reduction system generates a range for target object T. Then, the lowest value for the upper bound and the highest value for the lower bound are used as the final range for target object T.

In one example implementation, the resource allocation system may identify all routes by identifying sets of data objects, modify and reduce the sets of data objects based on specific, particular rules to generate data subsets, and identifying all unique combinations of subsets that begin or end with subsets relating to the first and second data object. For example, the resource allocation system may first store data indicative of all the data objects in the system, including the first and second base objects, in the memory. The resource allocation system may also store data indicative of one or more previously received transaction requests, each of the previously received transaction requests associated with a subset of the plurality of data objects.

Based on the stored data indicative of the plurality of data objects and the stored data indicative of the previously received transaction requests, the resource allocation system identifies all sets of data objects of the plurality of data objects that includes each of: (i) a first subset including the first base object and another data object associated therewith via at least one of the previously received transaction requests; (ii) a second subset including the second base object and another data object associated therewith via at least one of the previously received transaction requests; and (iii) one or more subsets including two intermediate data objects associated with each other via at least one of the previously received transaction requests, wherein each of the intermediate data objects are included in at least one of the other subsets, and wherein the first, second and the one or more subsets may be the same subsets. For example, in route A-B-C-T discussed above, where A is the known base object and T is the target object, objects B and C are intermediate base objects. The resource allocation system then identifies all unique combinations of the first, second and one or more subsets beginning with the first subset and ending with the second subset, each unique combination defining a route between the first base object and the second base object.

Such an example implementation using data sets may be visualized, for example, using a node graph of base objects that are connected if the system has received transaction requests for two connected base objects.

Accordingly, the system identifies a first subset of objects where the first base object is part of a received transaction request. The system identifies a second subset of objects where the second base object is part of a received transaction request. The first and second subsets may be the same, if, for example, the first and second base objects are only part of transaction requests where the two are in the same transaction request.

An exchange computing system implementing the range reduction system can compute a variety of routes, each leading to a range of values for target object T. All of the ranges can be considered together to generate a new, reduced range for target object T that is much smaller than a previously determined range. A smaller range enables selection of a more accurate settlement value, which better comports with transaction requests for other objects. A smaller range may also be associated with a smaller memory and storage requirement, thus reducing the computing resources necessary to represent information about the target object T. These advantages have a large overall impact on the efficiency and computing resource requirement of an exchange computing system when it is considered that an exchange computing system may have dozens or hundreds of target objects.

For example, as illustrated in FIG. 8, the range reduction system may determine that 12 different routes lead to 47.5 as the upper bound for T, 280 different routes lead to 47.3 as the upper bound for T, 11,355 different routes lead to 47.0 as the upper bound for T, 18 different routes lead to 46.6 as the upper bound for T, and two different routes lead to 46.5 as the upper bound for the value of target object T.

The exchange computing system implementing the disclosed range reduction system may also determine or compute that four different routes lead to 46.1 as the lower bound for the value of target object T, 1,323 different routes lead to 45.8 as the lower bound for the value of target object T, 10,894 different routes lead to 45.5 as the lower bound for the value of target object T, and 35 different routes lead to 45.3 as the lower bound for the value of target object T.

A pair of upper and lower bounds, as shown in FIG. 8, may be computed as the range for target object T, as described for example in connection with FIG. 6B. For example, the A-B-C-T route described in connection with FIG. 6B may be used to compute, or lead to, a range of 45.5 to 47 for target object T. The A-B-C-T route thus contributed one of the 11,355 different routes that leads to an upper bound of 47. The A-B-C-T route also contributed one of the 10,894 different routes that leads to a lower bound of 45.5.

Other routes, other than A-B-C-T, may result in different ranges, such as an A-C-D-E-T route (not shown) that leads to the range 45.3 to 47 for target object T. In that case, the A-C-D-E-T route may be understood to have contributed one of the 11,355 different routes that leads to an upper bound of 47, and one of the 35 different routes that leads to a lower bound of 45.3.

Referring back to FIG. 8, the system then identifies the lowest upper bound (namely, 46.5) and the highest lower bound (namely, 46.1) from the identified routes and defines a new range, Range 2, for target object T. The two routes leading to 46.5 as the lowest upper bound may all be completely different from the four routes leading to 46.1 as the highest lower bound. The range reduction system then selects, or prompts a user to select, a value for target object T from the reduced Range 2. Any value that is selected from within Range 2 for target object T ensures that all of the transaction requests that contributed to a route range, such as A-B-C-T, can still be performed by the exchange computing system. For example, as discussed above, the route A-B-C-T includes composite object data for composite object AB, BC and CT and leads to a range of 45.5 to 47. If a value for target object T is selected between 45.5 and 47, e.g., 45.8, then it can be ensured that the transaction requests for the composite objects AB, BC and CT can all still be performed, e.g., those requests are compatible with a 45.8 value of T.

When all of the ranges associated with the identified routes are considered, the range reduction system generates a much smaller range. In particular, the range reduction system reduces an initial Range 1 of target object T from 44 to 52 to a reduced Range 2 of 46.1 to 46.5. Selecting, by the exchange computing system, a value for T in the 46.1 to 46.5 range will ensure none of the transaction requests that are associated with each identified route become impossible to perform, or are rendered invalid, and will ensure that the selected value conforms to known values of the known base object.

It should be understood that if a value outside of Range 2 is selected for target object T, there is a possibility that some of the transaction requests received by the exchange computing system can no longer be performed or satisfied. For example, if the exchange computing system does not implement the disclosed range reduction system, the exchange computing system would only have information about Range 1 from which to deduce or determine a settlement price for target object T.

If, for example, a settlement price or value of 48 (i.e., average of 44 and 52 from Range 1) is selected as the final settlement price of target object T, any of the transaction requests that are associated with route ranges that led to upper bounds below 48 would be rendered invalid, or impossible to perform. In particular, the 12 different routes that lead to 47.5 as the upper bound for T, the 280 different routes that lead to 47.3 as the upper bound for T, the 11,355 different routes that lead to 47.0 as the upper bound for T, the 18 different routes that lead to 46.6 as the upper bound for T, and the two different routes that lead to 46.5 as the upper bound for the value of target object T would all become impossible to satisfy.

A route that becomes means impossible to satisfy means that at least one, and possibly all, of the composite object pairs that make up a route cannot be performed. If for example an upper bound associated with route A-B-C-T cannot be satisfied, that means that at least the transaction requests received for one of AB, BC, or CT which contributed to route A-B-C-T can no longer be satisfied.

For example, a transaction request to buy a spread object AB at a value of 30 may contribute to a A-B-C-T route range of target object T where 46.5 is computed to be the upper bound. If the value for target object T is selected to be 48, the transaction request to buy a spread object AB at a value of 30 can no longer be performed. That transaction request becomes incompatible with other portions of a system that must all fit together. That transaction request then becomes data that is no longer satisfied. The exchange computing system may be configured to notify the submitter of that transaction request that his or her submission cannot be satisfied. By selecting a value, or attempting to compute a value for target object T that is compatible with all other received transaction requests, the range reduction system minimizes discarding data, and is instead able to use all received data.

When a value for target object T is selected that is incompatible with a route range, or makes one or more of the received transaction requests impossible to perform, then the data associate with such received transaction requests may become irrelevant to the exchange computing system.

Similarly, if, for example, a settlement price or value of 45 is selected as the final settlement price of target object T, any of the transaction requests that are associated with route ranges that led to lower bounds above 45 would be rendered invalid, or impossible to perform. In particular, the four different routes that lead to 46.1 as the lower bound for the value of target object T, the 1,323 different routes that lead to 45.8 as the lower bound for the value of target object T, the 10,894 different routes that lead to 45.5 as the lower bound for the value of target object T, and the 35 different routes that lead to 45.3 as the lower bound for the value of target object T would all become impossible to satisfy.

The reduced range computed by the exchange computing system may be user configurable. For example, referring to FIG. 8, instead of considering the number of unique routes that lead to a given price or value point, the system may consider how many different orders (in the form of electronic data transaction request messages), submitted by users (e.g., trades), are associated with each computed value point. Routes that are associated with more orders may be more heavily weighted, which weighting may be user configurable. For example, if the two routes that are associated with the lowest upper bound of 46.5 are based on 3 orders, and the 18 paths that are associated with the upper bound of 46.6 are based on 500 (e.g., more) orders, the user may decide to, or the system may, give more weight to the value of 46.6. Giving more weight to a value increases the likelihood that the heavily weighted value is selected.

Alternatively, the system may weigh, or allow the user to configure the weight associated with a route, based on the number of units associated with submitted values. For example, if the two routes that are associated with the lowest upper bound of 46.5 are also associated with 15 units of the financial instrument represented by target object T, and the 18 paths that are associated with the upper bound of 46.6 are also associated with 400 (e.g., more) units of the financial instrument represented by target object T, the user may decide to, or the system may, give more weight to the value of 46.6.

Although the above example begins with a known base object A and finds routes leading to the target object T, the system may be configured to instead start with the target object T and find all routes to the known base object A. The system may also be configured to find ranges for more than one target object. And, for each target object, the system may be configured to use multiple known base objects. For example, in the example of FIG. 7, the system may identify object J as a known base object, and may begin with the known value of J to apply spread range data to determine ranges for target object T.

It should accordingly be appreciated that each spread range that is applied by the system may increase the overall range of the target object T. For example, if the system has received data (e.g., a spread range, or a bid ask range) for a composite object that includes both the known base object and the target object, the system can apply the spread range to the known base object to obtain a range of values for the target object. Each “hop” or additional composite object range that is considered, or is necessary to reach target object T from a known base object, may increase the eventual range of the target object.

Thus, referring back to FIG. 7, for identified route A-B-K-T (which again is a route that includes shorter routes that connect due to common, shared base objects, namely, routes A-B, B-K, and K-T), applying composite object BK to a range of values for object B may expand the range of values for base object K, which in turn may expand the range of values for target object T.

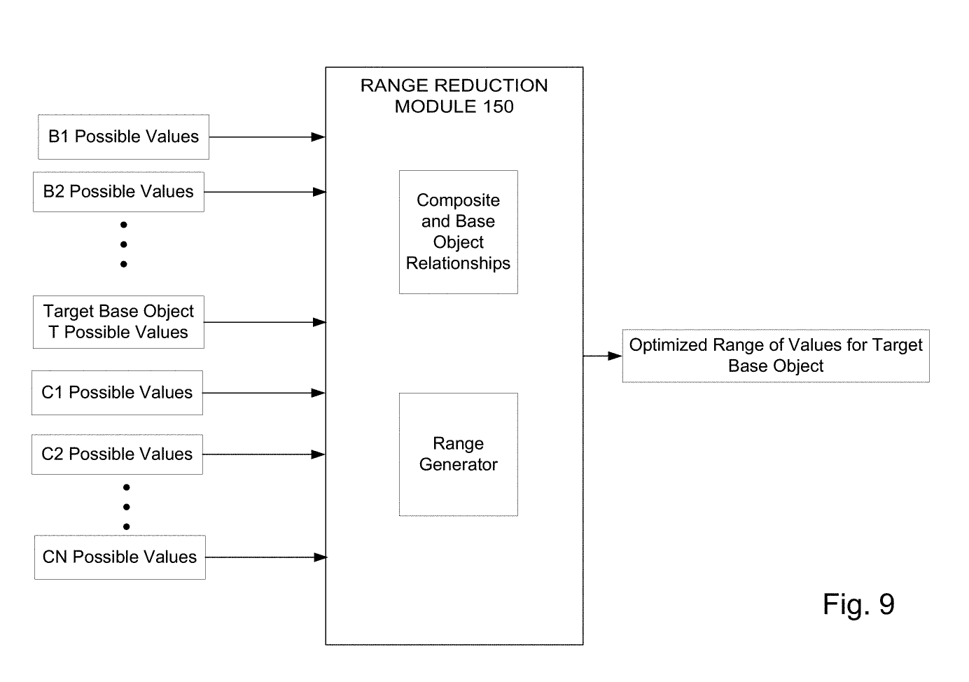

FIG. 9 illustrates an example input/output block diagram illustrating an example range reduction module 150 that receives possible values for base objects B1, B2, . . . T and composite objects C1, C2, . . . CN. One of the base object value ranges, e.g., B1, may be so narrow that the exchange computing system can determine a known settlement value for the base object, e.g., the base object may be a known base object. Another of the base objects, e.g., a target object T, may receive a wide range of values, thus base object T may be associated with a first range of values, but not be associated with a settlement value. The range reduction module 150 identifies all routes from the known base object B1 to the target object T and uses the known base object value and composite object values, as described herein, to generate a range of values for T, which is smaller than the initially received range of values for T. In one embodiment, the range reduction module stores information about the relationships between the various base and composite objects. As discussed herein, composite objects may define relationships between multiple objects, e.g., between two base objects, or between two composite objects, or a base object and a composite object. In one embodiment, a composite object may be represented by an equation, such as equation 1.

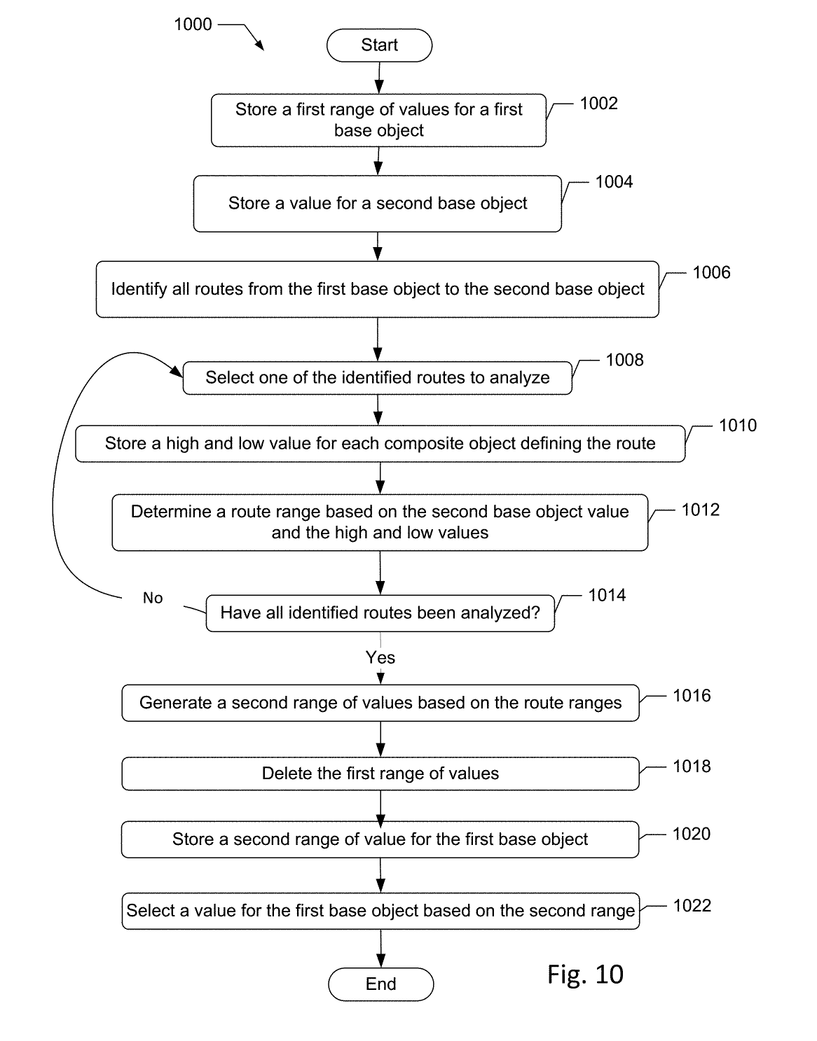

FIG. 10 illustrates an example flowchart 1000 indicating an example method of implementing a range reduction system, as may be implemented with computer devices and computer networks, such as those described with respect to FIGS. 1 and 2. Embodiments may involve all, more or fewer actions indicated by the blocks of FIG. 10. The actions may be performed in the order or sequence shown or in a different sequence. In one embodiment, the steps of FIG. 10 may be carried out by range reduction module 150.

The method or operation of the range reduction system includes storing a first range of values for a first base object, as shown in block 1002. The first base object may be a target object, for which the method generates a reduced range that requires less storage and memory, increases user flexibility for weighting associated object relationships, and enables selection of a value thereof that is compatible with transaction requests received for other system objects.

The method also includes storing a value for a second base object, as shown in block 1004. The second base object may be a known object, or an object for which the received range of values is so narrow that the system can conclude the base object's final or settlement value. The method includes identifying all routes between the first base object and the second base object, as shown in block 1006. Each identified route may be defined by one or more composite objects, and each composite object may be associated with at least two constituent base objects. Each identified route may also include at least one composite object that is associated with at least one of the first base object or the second base object.

For each identified route, the method or process 1000 may include storing a high and a low value for each composite object defining the identified route, as shown in block 1010, and determining a route range based on the second base object value and the high and low values of the composite objects defining the identified route, as shown in block 1012. After steps 1010 and 1012 have been applies to all identified routes, the process includes generating a second range of values based on the route ranges of the identified routes, as shown in block 1016. The second range of values may be smaller than the first range of values initially associated with the first base object. The process then includes deleting the first range of values, as shown in block 1018, storing the second range of values for the first base object, as shown in block 1020, and selecting a value for the first base object based on the second range, as shown in block 1022.

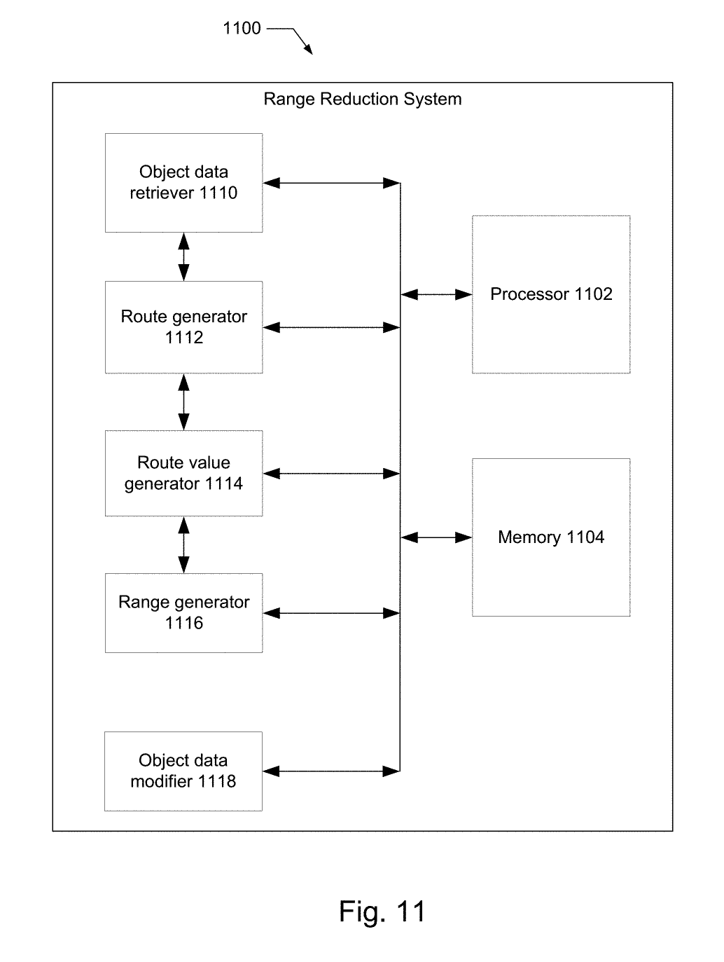

FIG. 11 depicts a block diagram of a system 1100 for generating a reduced range for a target object, which in an exemplary implementation, is implemented as part of the range reduction module 150 of the exchange computer system 100. In one embodiment, the system 1100 is coupled with one or more of the order processing module 136, the order book module 110, or the message management module 140 described above and evaluates incoming messages, and monitors the relevant parameters of the order book maintained for the product. It will be appreciated that the system 1100 may be coupled to other modules of the exchange computer system 100 so as to have access to the relevant parameters as described herein and initiate the requisite actions as further described. The disclosed embodiments may be implemented separately for each market/order book to be monitored, such as a separate process or thread, or may be implemented as a single system for all markets/order books to be monitored thereby.

The system 1100 includes a processor 1102 and a memory 1104 coupled therewith which may be implemented as a processor 202 and memory 204 as described with respect to FIG. 2.

The system 1100 further includes an object data retriever 1110 that retrieves and associates: a first range of values with a first base object; and a value with a second base object.

The system 1100 further includes a route generator 1112 that identifies all routes between the first base object and the second base object, wherein each identified route is defined by one or more composite objects, wherein each composite object is associated with at least two constituent base objects, and wherein each identified route includes at least one composite object that is associated with at least one of the first base object or the second base object.

The system 1100 further includes a route value generator 1114 that, for each identified route, associates a high and a low value with each composite object defining the identified route; and determines a route range based on the second base object value and the high and low values of the composite objects defining the identified route.

The system 1100 further includes a range generator 1116 that generates a second range of values based on the route ranges of the identified routes, the second range of values being smaller than the first range of values.

The system 1100 further includes an object data modifier 1118 that: associates the second range of values with the first base object; and selects a value for the first base object based on the second range.

Referring back to FIG. 1A, the trading network environment shown in FIG. 1A includes exemplary computer devices 114, 116, 118, 120 and 122 which depict different exemplary methods or media by which a computer device may be coupled with the exchange computer system 100 or by which a user may communicate, e.g., send and receive, trade or other information therewith. It should be appreciated that the types of computer devices deployed by traders and the methods and media by which they communicate with the exchange computer system 100 is implementation dependent and may vary and that not all of the depicted computer devices and/or means/media of communication may be used and that other computer devices and/or means/media of communications, now available or later developed may be used. Each computer device, which may comprise a computer 200 described in more detail with respect to FIG. 2, may include a central processor, specifically configured or otherwise, that controls the overall operation of the computer and a system bus that connects the central processor to one or more conventional components, such as a network card or modem. Each computer device may also include a variety of interface units and drives for reading and writing data or files and communicating with other computer devices and with the exchange computer system 100. Depending on the type of computer device, a user can interact with the computer with a keyboard, pointing device, microphone, pen device or other input device now available or later developed.

An exemplary computer device 114 is shown directly connected to exchange computer system 100, such as via a T1 line, a common local area network (LAN) or other wired and/or wireless medium for connecting computer devices, such as the network 220 shown in FIG. 2 and described with respect thereto. The exemplary computer device 114 is further shown connected to a radio 132. The user of radio 132, which may include a cellular telephone, smart phone, or other wireless proprietary and/or non-proprietary device, may be a trader or exchange employee. The radio user may transmit orders or other information to the exemplary computer device 114 or a user thereof. The user of the exemplary computer device 114, or the exemplary computer device 114 alone and/or autonomously, may then transmit the trade or other information to the exchange computer system 100.

Exemplary computer devices 116 and 118 are coupled with a local area network (“LAN”) 124 which may be configured in one or more of the well-known LAN topologies, e.g., star, daisy chain, etc., and may use a variety of different protocols, such as Ethernet, TCP/IP, etc. The exemplary computer devices 116 and 118 may communicate with each other and with other computer and other devices which are coupled with the LAN 124. Computer and other devices may be coupled with the LAN 124 via twisted pair wires, coaxial cable, fiber optics or other wired or wireless media. As shown in FIG. 1A, an exemplary wireless personal digital assistant device (“PDA”) 122, such as a mobile telephone, tablet based compute device, or other wireless device, may communicate with the LAN 124 and/or the Internet 126 via radio waves, such as via WiFi, Bluetooth and/or a cellular telephone based data communications protocol. PDA 122 may also communicate with exchange computer system 100 via a conventional wireless hub 128.

FIG. 1A also shows the LAN 124 coupled with a wide area network (“WAN”) 126 which may be comprised of one or more public or private wired or wireless networks. In one embodiment, the WAN 126 includes the Internet. The LAN 124 may include a router to connect LAN 124 to the Internet 126. Exemplary computer device 120 is shown coupled directly to the Internet 126, such as via a modem, DSL line, satellite dish or any other device for connecting a computer device to the Internet 126 via a service provider therefore as is known. LAN 124 and/or WAN 126 may be the same as the network 220 shown in FIG. 2 and described with respect thereto.

Users of the exchange computer system 100 may include one or more market makers 130 which may maintain a market by providing constant bid and offer prices for a derivative or security to the exchange computer system 100, such as via one of the exemplary computer devices depicted. The exchange computer system 100 may also exchange information with other match or trade engines, such as trade engine 138. One skilled in the art will appreciate that numerous additional computers and systems may be coupled to exchange computer system 100. Such computers and systems may include clearing, regulatory and fee systems.

The operations of computer devices and systems shown in FIG. 1A may be controlled by computer-executable instructions stored on a non-transitory computer-readable medium. For example, the exemplary computer device 116 may store computer-executable instructions for receiving order information from a user, transmitting that order information to exchange computer system 100 in electronic messages, extracting the order information from the electronic messages, executing actions relating to the messages, and/or calculating values from characteristics of the extracted order to facilitate matching orders and executing trades. In another example, the exemplary computer device 118 may include computer-executable instructions for receiving market data from exchange computer system 100 and displaying that information to a user.

Numerous additional servers, computers, handheld devices, personal digital assistants, telephones and other devices may also be connected to exchange computer system 100. Moreover, one skilled in the art will appreciate that the topology shown in FIG. 1A is merely an example and that the components shown in FIG. 1A may include other components not shown and be connected by numerous alternative topologies.

Referring back to FIG. 2, an illustrative embodiment of a general computer system 200 is shown. The computer system 200 can include a set of instructions that can be executed to cause the computer system 200 to perform any one or more of the methods or computer based functions disclosed herein. The computer system 200 may operate as a standalone device or may be connected, e.g., using a network, to other computer systems or peripheral devices. Any of the components discussed above, such as the processor 202, may be a computer system 200 or a component in the computer system 200. The computer system 200 may be specifically configured to implement a match engine, margin processing, payment or clearing function on behalf of an exchange, such as the Chicago Mercantile Exchange, of which the disclosed embodiments are a component thereof.

In a networked deployment, the computer system 200 may operate in the capacity of a server or as a client user computer in a client-server user network environment, or as a peer computer system in a peer-to-peer (or distributed) network environment. The computer system 200 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 200 can be implemented using electronic devices that provide voice, video or data communication. Further, while a single computer system 200 is illustrated, the term “system” shall also be taken to include any collection of systems or sub-systems that individually or jointly execute a set, or multiple sets, of instructions to perform one or more computer functions.

As illustrated in FIG. 2, the computer system 200 may include a processor 202, e.g., a central processing unit (CPU), a graphics processing unit (GPU), or both. The processor 202 may be a component in a variety of systems. For example, the processor 202 may be part of a standard personal computer or a workstation. The processor 202 may be one or more general processors, digital signal processors, specifically configured processors, application specific integrated circuits, field programmable gate arrays, servers, networks, digital circuits, analog circuits, combinations thereof, or other now known or later developed devices for analyzing and processing data. The processor 202 may implement a software program, such as code generated manually (i.e., programmed).

The computer system 200 may include a memory 204 that can communicate via a bus 208. The memory 204 may be a main memory, a static memory, or a dynamic memory. The memory 204 may include, but is not limited to, computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 204 includes a cache or random access memory for the processor 202. In alternative embodiments, the memory 204 is separate from the processor 202, such as a cache memory of a processor, the system memory, or other memory. The memory 204 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 204 is operable to store instructions executable by the processor 202. The functions, acts or tasks illustrated in the figures or described herein may be performed by the programmed processor 202 executing the instructions 212 stored in the memory 204. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 200 may further include a display unit 214, such as a liquid crystal display (LCD), an organic light emitting diode (OLED), a flat panel display, a solid state display, a cathode ray tube (CRT), a projector, a printer or other now known or later developed display device for outputting determined information. The display 214 may act as an interface for the user to see the functioning of the processor 202, or specifically as an interface with the software stored in the memory 204 or in the drive unit 206.

Additionally, the computer system 200 may include an input device 216 configured to allow a user to interact with any of the components of system 200. The input device 216 may be a number pad, a keyboard, or a cursor control device, such as a mouse, or a joystick, touch screen display, remote control or any other device operative to interact with the system 200.

In a particular embodiment, as depicted in FIG. 2, the computer system 200 may also include a disk or optical drive unit 206. The disk drive unit 206 may include a computer-readable medium 210 in which one or more sets of instructions 212, e.g., software, can be embedded. Further, the instructions 212 may embody one or more of the methods or logic as described herein. In a particular embodiment, the instructions 212 may reside completely, or at least partially, within the memory 204 and/or within the processor 202 during execution by the computer system 200. The memory 204 and the processor 202 also may include computer-readable media as discussed above.

The present disclosure contemplates a computer-readable medium that includes instructions 212 or receives and executes instructions 212 responsive to a propagated signal, so that a device connected to a network 220 can communicate voice, video, audio, images or any other data over the network 220. Further, the instructions 212 may be transmitted or received over the network 220 via a communication interface 218. The communication interface 218 may be a part of the processor 202 or may be a separate component. The communication interface 218 may be created in software or may be a physical connection in hardware. The communication interface 218 is configured to connect with a network 220, external media, the display 214, or any other components in system 200, or combinations thereof. The connection with the network 220 may be a physical connection, such as a wired Ethernet connection or may be established wirelessly. Likewise, the additional connections with other components of the system 200 may be physical connections or may be established wirelessly.

The network 220 may include wired networks, wireless networks, or combinations thereof. The wireless network may be a cellular telephone network, an 802.11, 802.16, 802.20, or WiMax network. Further, the network 220 may be a public network, such as the Internet, a private network, such as an intranet, or combinations thereof, and may utilize a variety of networking protocols now available or later developed including, but not limited to, TCP/IP based networking protocols.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated or otherwise specifically configured hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well. Feedback provided to the user can be any form of sensory feedback, e.g., visual feedback, auditory feedback, or tactile feedback. Input from the user can be received in any form, including acoustic, speech, or tactile input.

Embodiments of the subject matter described in this specification can be implemented in a computing system that includes a back end component, e.g., a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

It should be appreciated that the disclosed embodiments may be applicable to other types of messages depending upon the implementation. Further, the messages may comprise one or more data packets, datagrams or other collection of data formatted, arranged configured and/or packaged in a particular one or more protocols, e.g., the FIX protocol, TCP/IP, Ethernet, etc., suitable for transmission via a network 214 as was described, such as the message format and/or protocols described in U.S. Pat. No. 7,831,491 and U.S. Patent Publication No. 2005/0096999 A1, both of which are incorporated by reference herein in their entireties and relied upon. Further, the disclosed message management system may be implemented using an open message standard implementation, such as FIX, FIX Binary, FIX/FAST, or by an exchange-provided API.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the described embodiments should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

What is claimed is:

1. A computer implemented method comprising:
storing, in a memory, by a processor, a first range of values for a first base object;
storing, in the memory, by the processor, a value for a second base object;
identifying, by the processor, all routes between the first base object and the second base object, wherein each identified route is defined by one or more composite objects, wherein each composite object is associated with at least two constituent base objects, and wherein each identified route includes at least one composite object that is associated with at least one of the first base object or the second base object;
for each identified route,
storing, in the memory, by the processor, a high and a low value for each composite object defining the identified route; and
determining, by the processor, a route range based on the second base object value and the high and low values of the composite objects defining the identified route;
generating a second range of values based on the route ranges of the identified routes, the second range of values being smaller than the first range of values;
deleting, from the memory, by the processor, the first range of values;
storing, in the memory, by the processor, the second range of values for the first base object; and
selecting, by the processor, a value for the first base object based on the second range of values.

2. The computer implemented method of claim 1, the identifying of all the routes between the first base object and the second base object further comprising:
storing data indicative of a plurality of data objects including the first and second base objects in the memory;
storing data indicative of one or more previously received transaction requests, each of the previously received transaction requests associated with a subset of the plurality of data objects;
based on the stored data indicative of the plurality of data objects and the stored data indicative of the previously received transaction requests, identifying all sets of data objects of the plurality of data objects, wherein each identified set includes each of:
a first subset including the first base object and another data object associated therewith via at least one of the previously received transaction requests;
a second subset including the second base object and another data object associated therewith via at least one of the previously received transaction requests; and
one or more subsets including two intermediate data objects associated with each other via at least one of the previously received transaction requests, wherein each of the intermediate data objects are included in at least one of the other subsets, and wherein the first, second and the one or more subsets may be the same subsets; and
identifying all unique combinations of the first, second and one or more subsets beginning with the first subset and ending with the second subset, each unique combination defining a route between the first base object and the second base object.

3. The computer implemented method of claim 1, wherein the base objects and the composite objects represent financial instruments traded in an exchange computing system.

4. The computer implemented method of claim 3, wherein the base objects represent outright financial instruments, and wherein the composite objects represent spread financial instruments associated with two or more outright financial instruments.

5. The computer implemented method of claim 4, wherein each outright financial instrument is associated with a delivery date.

6. The computer implemented method of claim 5, wherein the outright financial instruments differ only in their respective delivery dates.

7. The computer implemented method of claim 6, wherein the financial instrument represented by the second base object is associated with a delivery date occurring before the delivery date associated with the financial instrument representing the first base object.

8. The computer implemented method of claim of claim 1, wherein the values in the first range of values associated with the first base object, the value associated with the second base object, and the values associated with the composite objects are based on electronic data transaction request messages received by an exchange computing system, each electronic data transaction request message including a request to perform a transaction at a specified value related to the first base object, the second base object, and the composite objects, respectively.

9. The computer implemented method of claim 8, further comprising,
for each identified route,
identifying a number of electronic data transaction request messages associated with each composite object defining the identified route; and
determining a route message number based on the number of electronic data transaction request messages associated with each composite object defining the identified route; and
generating the second range of values based on the route ranges and the route message numbers of the identified routes.

10. The computer implemented method of claim 8, further comprising
for each identified route,
identifying a quantity associated with electronic data transaction request messages associated with each composite object defining the identified route; and
determining a route quantity based on the quantity associated with electronic data transaction request messages associated with each composite object defining the identified route; and
generating the second range of values based on the route ranges and the route quantities of the identified routes.

11. The computer implemented method of claim 8, wherein a transaction is to purchase or relinquish a quantity of objects at a specified value.

12. The computer implemented method of claim 1, wherein the values are based on resting orders or completed orders.

13. The computer implemented method of claim 1, wherein the first base object, the second base object and the composite objects represent financial instruments associated with a same product, the method further comprising:
associating a value with a third base object representing a financial instrument associated with the same product;
identifying all routes between the first base object and the third base object, wherein each identified route is defined by one or more composite objects, and wherein each identified route includes at least one composite object that is associated with at least one of the first base object or the third base object;
for each identified route,
associating a high and a low value with each composite object defining the identified route;
determining a route range based on the third base object value and the high and low values of the composite objects defining the identified route; and
generating the second range of values based on the route ranges of the routes identified between the first base object and the second base object and the route ranges of the routes identified between the first base object and the third base object.

14. The computer implemented method of claim of claim 1, wherein the first base object, the second base object and the composite objects represent financial instruments associated with a same product, the method further comprising:
associating a third range of values with a fourth base object representing a financial instrument associated with the same product;
identifying all routes between the fourth base object and the second base object, and wherein each identified route includes at least one composite object that is associated with at least one of the fourth base object or the second base object;
for each identified route,
associating a high and a low value with each composite object defining the identified route;
determining a route range based on the second base object value and the high and low values of the composite objects defining the identified route;
generating a fourth range of values based on the route ranges of the identified routes, the fourth range of values being smaller than the third range of values;
associating the fourth range of values with the fourth base object; and
selecting a value for the fourth base object based on the fourth range.

15. The computer implemented method of claim 1, wherein the value of each of the composite objects is determined independently of the values of the constituent base objects.

16. The computer implemented method of claim 1, wherein the first range of values occupies a quantity of the memory corresponding to a first size, and the second range of values occupies a quantity of the memory corresponding to a second size smaller than the first size.

17. A computer implemented method comprising:
associating a value with a second base object;
identifying all routes between a first base object and the second base object, wherein each identified route is defined by one or more composite objects, wherein each composite object is associated with at least two constituent base objects, and wherein each identified route includes at least one composite object that is associated with at least one of the first base object or the second base object;
for each identified route,
associating a high and a low value with each composite object defining the identified route; and
determining a route range based on the second base object value and the high and low values of the composite objects defining the identified route;
generating a range of values based on the route ranges of the identified routes;
associating the range of values with the first base object; and
selecting a value for the first base object based on the second range of values.

18. A computer system including a computer processor coupled with a memory, the computer processor configured to:
associate a first range of values with a first base object;
associate a value with a second base object;
identify all routes between the first base object and the second base object, wherein each identified route is defined by one or more composite objects, wherein each composite object is associated with at least two constituent base objects, and wherein each identified route includes at least one composite object that is associated with at least one of the first base object or the second base object;
for each identified route,
associate a high and a low value with each composite object defining the identified route; and
determine a route range based on the second base object value and the high and low values of the composite objects defining the identified route;
generate a second range of values based on the route ranges of the identified routes, the second range of values being smaller than the first range of values;
delete the first range of values;
associate the second range of values with the first base object; and
select a value for the first base object based on the second range of values.

19. A computer system comprising:
a processor in communication with a memory;
means for associating a first range of values with a first base object;
means for associating a value with a second base object;
means for identifying all routes between the first base object and the second base object, wherein each identified route is defined by one or more composite objects, wherein each composite object is associated with at least two constituent base objects, and wherein each identified route includes at least one composite object that is associated with at least one of the first base object or the second base object;
for each identified route,
means for associating a high and a low value with each composite object defining the identified route; and
means for determining a route range based on the second base object value and the high and low values of the composite objects defining the identified route;
means for generating a second range of values based on the route ranges of the identified routes, the second range of values being smaller than the first range of values;
means for deleting the first range of values;
means for associating the second range of values with the first base object; and
means for selecting a value for the first base object based on the second range of values.

20. The computer system of claim 19 including a memory, wherein the first range of values occupies a quantity of the memory corresponding to a first size, and the second range of values occupies a quantity of the memory corresponding to a second size smaller than the first size.

21. A computer system including:
an object data retriever that retrieves and associates:
a first range of values with a first base object; and
a value with a second base object;
a route generator that identifies all routes between the first base object and the second base object, wherein each identified route is defined by one or more composite objects, wherein each composite object is associated with at least two constituent base objects, and wherein each identified route includes at least one composite object that is associated with at least one of the first base object or the second base object;
a route value generator that, for each identified route,
associates a high and a low value with each composite object defining the identified route; and
determines a route range based on the second base object value and the high and low values of the composite objects defining the identified route;
a range generator that generates a second range of values based on the route ranges of the identified routes, the second range of values being smaller than the first range of values; and
an object data modifier that:
associates the second range of values with the first base object; and
selects a value for the first base object based on the second range of values.
